(19) United States
(12) Patent Application Publication
(10) Pub. No.: US 2026/0064645 A1
(43) Pub. Date: Mar. 5, 2026

(54) SYSTEM AND METHOD FOR PROVIDING A REVISION HISTORY FOR USE WITH A DATA ANALYTICS ENVIRONMENT

(71) Applicant: ORACLE INTERNATIONAL CORPORATION, Redwood Shores, CA (US)

(72) Inventors: Diego Cabrera, Zapopan (MX); Avinash Vaithiyam Krishnaram, Addison, TX (US); Lawrence Hand, San Francisco, CA (US); Matthew Jakubiak, Larkspur, CO (US)

(21) Appl. No.: 19/302,752

(22) Filed: Aug. 18, 2025

Related U.S. Application Data
(60) Provisional application No. 63/690,572, filed on Sep. 4, 2024.

(51) Int. Cl. G06F 16/21; G06F 16/23

(52) U.S. Cl. CPC G06F 16/219; G06F 16/2358

(57) ABSTRACT

Embodiments described herein are generally related to data analytics environments, and are particularly directed to systems and methods for providing a revision history for use with a data analytics environment. The system includes a computer that includes one or more processors and that provides access to the data analytics environment, a revision history handler application running at the data analytics environment, and a user interface running at a client device and being in operative communication with the revision history handler application. The revision history handler application is configured to store, in a workbook folder of an artifacts catalog of the data analytics environment, current workbook metadata relating to a current workbook, a plurality of previous workbook versions of the current workbook, and a plurality of previous workbook version metadata sets each being related to a corresponding one of a plurality of previous workbook versions of the current workbook.

### Claim of Priority and Cross-Reference to Related Applications:

This application claims the benefit of priority to U.S. Provisional Patent Application titled “SYSTEM AND METHOD FOR PROVIDING A REVISION HISTORY FOR USE WITH A DATA ANALYTICS ENVIRONMENT,” Application No. 63/690,572, filed September 4, 2024; which above application and the contents thereof is herein incorporated by reference.

### Technical Field

Embodiments described herein are generally related to data analytics environments, and are particularly directed to systems and methods for providing a revision history for use with a data analytics environment.

### Background:

Generally described, data analytics enables the computer-based examination of an amount of data, to derive an analytic data, metrics, conclusions, or other types of analytical information from, or descriptive of, the source data. Systems and methods can be used, for example, to generate an analytic business intelligence data, such as a set of data metrics or measures operating as key performance indicators, which analytically describe an organization’s business-related data in a format useful to its decision-makers.

Some data analytics environments allow users to create multiple artifacts such as workbooks, datasets, sequences, and the like. However, these data analytics environments lack versioning capabilities which presents challenges for users and administrators including for example risk of data loss, difficulty in tracking changes, and potential conflicts during collaborative work on the artifacts that are created. These are not only user-specific problems, but are also problems for support teams that may need to diagnose customer or client issues without having the benefit of a view into or at prior versions of metadata related to the artifacts that are created in the data analytics environments.

Without a versioning system, accidental changes or deletions, the multiple artifacts that are created in the data analytics environment such as workbooks, datasets, sequences, and the like can result in the loss of valuable insights and analysis.

Users of prior systems are unable to easily track changes made to the multiple artifacts such as workbooks over time, making it challenging to understand how analyses have evolved or how to revert to previous versions if necessary.

Collaborative work on multiple artifacts such as workbooks becomes challenging as multiple users may inadvertently overwrite each other's changes, leading to conflicts and loss of work.

In addition to the above, some organizations may have compliance requirements or other policies that mandate or otherwise require the tracking of changes made to analytical reports. The absence of versioning features makes it difficult to meet these requirements effectively.

Simple commercial systems external to the data analytics environment and that may be available may be used to expose a list of “versions” of a workbook to a user via a user interface. However, such systems are unable to effect rollback of the actual content of a workbook to the content of an earlier version of the workbook. Such systems are further unable to effect a restore or re-application of the state of restore filters, layouts, visualizations, and other configurations to the state of a selected earlier version of the workbook.

### Summary:

Embodiments described herein are generally related to data analytics environments, and are particularly directed to systems and methods for providing a revision history for use with a data analytics environment.

In any of the implementations herein, systems and methods are provided for use with a data analytics environment to provide a revision history of workbooks enabling a user to be able to track changes made to the workbooks, including modifications, additions, and/or deletions of content.

In any of the implementations herein, systems and methods are provided for use with a data analytics environment to provide a revision history of workbooks enabling a user to be able to revert to previous versions of a workbook to recover lost data or restore previous analysis states.

In accordance with an aspect, a system is provided for use with a data analytics environment to provide a workbook revision history of changes made to a workbook for use with the data analytics environment.

The system includes a computer that includes one or more processors and that provides access to the data analytics environment, a revision history handler application running at the data analytics environment, and a user interface running at a client device and being in operative communication with the revision history handler application. The revision history handler application is configured to store, in a workbook folder of an artifacts catalog of the data analytics environment, current workbook metadata relating to a current workbook, and a plurality of previous workbook version metadata sets each being related to a corresponding one of a plurality of previous workbook versions of the current workbook.

The revision history handler application is responsive to an initialization request received from the user interface to provide to the user interface one or more of the current workbook metadata relating to the current workbook, and/or any of the plurality of previous workbook versions of the current workbook.

The user interface is operable to display the current workbook in an active edit display pane of the client device that is configured to receive current workbook change commands for making changes to the current workbook at the client device by a user of the system.

The user interface is operable to display in a revision history display pane of the client device a current version history image based on the current workbook metadata relating to the current workbook displayed in the active edit display pane and a plurality of previous version history images based on the plurality of previous workbook version metadata sets each being related to the corresponding ones of the plurality of previous workbook versions.

In any of the embodiments herein, the user interface comprises a version control service running at the client device, the version control service being in operative communication with a cache at the client device, wherein the version control service is operable to persist one or more of the current workbook, the current workbook metadata, and/or any of the plurality of previous workbook versions of the current workbook received from the revision history handler application in the cache at the client device.

In any of the embodiments herein, the user interface is operable to receive the current workbook change commands for making the changes to the current workbook at the client device by the user of the system, generate based on the changes made to the current workbook an updated workbook and updated workbook metadata related to the updated workbook, and display the updated workbook in the active edit display pane of the client device, and the version control service is operable to selectively in response to a save command received from the user via the active edit display pane persist the updated workbook and the updated workbook metadata to the cache at the client device.

In any of the embodiments herein, the version control service is operable to communicate the updated workbook and the updated workbook metadata to the revision history handler application running at the data analytics environment in response to receiving the save command from the user via the active edit display pane, the workbook folder of the artifacts catalog of the data analytics environment comprises a revisions.json file, and the revision history handler application is operable to save the updated workbook metadata to the revisions.json file.

In any of the embodiments herein, the user interface is operable to receive a reset request from the user, and the version control service is operable responsive to the user interface receiving the reset request to purge selected ones of the plurality of previous workbook version metadata sets from the cache at the client device, wherein a focused workbook being displayed in the active edit display pane of the client device and focused workbook metadata relating to the focused workbook being displayed in the active edit display pane are persisted to the cache at the client device.

In any of the embodiments herein, the user interface is operable to display the current version history image related to the current workbook metadata in the revision history display pane of the client device in association with a first set of visual indicia indicating to the user of the client device that the current workbook displayed in the active edit display pane of the client device is a Current Revision of the current workbook;

In any of the embodiments herein, the user interface is operable to display the plurality of previous version history images related to the plurality of previous workbook version metadata sets in the revision history display pane of the client device in association with a second set of visual indicia indicating for each of the plurality of previous workbook versions one or more of a timestamp indicating a time at which that version was saved, an author of that version, a user that modified that version, a user that issued a save command to the version control service relative to that version, and/or a customized name of that version.

In any of the embodiments herein, the user interface is operable to receive a desired previous workbook restore request based on the user selecting a desired previous version history image from among the plurality of previous version history images displayed in the revision history display pane of the client device, the selected desired previous version history image being related to a desired previous workbook version metadata set from among the plurality of previous workbook version metadata sets, the desired previous workbook version metadata set corresponding to a desired previous workbook version.

In any of the embodiments herein, the user interface is operable to restore the desired previous workbook version for display in the active edit display pane of the client device for making changes to the desired previous workbook version at the client device by the user of the system.

In accordance with a further aspect, a method is provided for use with a data analytics environment to provide a workbook revision history of changes made to a workbook for use with the data analytics environment.

The method includes providing a computer including one or more processors, wherein the computer provides access to the data analytics environment. The method includes providing a revision history handler application running at the data analytics environment, wherein the revision history handler application is configured to store, in a workbook folder of an artifacts catalog of the data analytics environment, current workbook metadata relating to a current workbook, and a plurality of previous workbook version metadata sets each being related to a corresponding one of a plurality of previous workbook versions of the current workbook.

The method includes providing a user interface running at a client device, wherein the user interface is in operative communication with the revision history handler application. The method includes providing to the user interface, by the revision history handler application responsive to receiving an initialization request received from the user interface, one or more of the current workbook, the current workbook metadata, and/or any of the plurality of previous workbook versions of the current workbook.

The method includes displaying, by the user interface, the current workbook in an active edit display pane of the client device that is configured to receive current workbook change commands for making changes to the current workbook at the client device by a user of the system.

The method includes displaying in a revision history display pane of the client device, by the user interface, a current version history image based on the current workbook metadata relating to the current workbook displayed in the active edit display pane and a plurality of previous version history images based on the plurality of previous workbook version metadata sets each being related to the corresponding ones of the plurality of previous workbook versions.

In any of the embodiments herein, the method further includes providing a version control service running at the client device, the version control service being in operative communication with a cache at the client device, and persisting, by the version control service, one or more of the current workbook, the current workbook metadata, and/or the plurality of previous workbook version metadata sets received from the revision history handler application in the cache at the client device.

In any of the embodiments herein, the method further includes receiving by the user interface the current workbook change commands for making the changes to the current workbook at the client device by the user of the system, generating by the user interface based on the changes made to the current workbook an updated workbook and updated workbook metadata related to the updated workbook, displaying by the user interface the updated workbook in the active edit display pane of the client device, and selectively persisting by the version control service in response to a save command received from the user via the active edit display pane the updated workbook and the updated workbook metadata to the cache at the client device.

In any of the embodiments herein, the method further includes communicating by the version control service the updated workbook and the updated workbook metadata to the revision history handler application running at the data analytics environment in response to receiving the save command from the user via the active edit display pane, and saving, by the revision history handler application, the updated workbook metadata to a revisions.json file of the workbook folder of the artifacts catalog of the data analytics environment.

In any of the embodiments herein, the method further includes receiving by the user interface a reset request from the user, purging by the version control service responsive to the user interface receiving the reset request selected ones of the plurality of previous workbook version metadata sets from the cache at the client device, and persisting to the cache at the client device by the version control service a focused workbook being displayed in the active edit display pane of the client device and focused workbook metadata relating to the focused workbook being displayed in the active edit display pane.

In any of the embodiments herein, the method further includes displaying by the user interface the current version history image related to the current workbook metadata in the revision history display pane of the client device in association with a first set of visual indicia indicating to the user of the client device that the current workbook displayed in the active edit display pane of the client device is a Current Revision of the current workbook, and displaying by the user interface the plurality of previous version history images related to the plurality of previous workbook version metadata sets in the revision history display pane of the client device in association with a second set of visual indicia indicating for each of the plurality of previous workbook versions one or more of: a timestamp indicating a time at which that version was saved; an author of that version; a user that modified that version; a user that issued a save command to the version control service relative to that version; and/or a customized name of that version.

In any of the embodiments herein, the method further includes receiving by the user interface a desired previous workbook restore request based on the user selecting a desired previous version history image from among the plurality of previous version history images displayed in the revision history display pane of the client device the selected desired previous version history image being related to a desired previous workbook version metadata set from among the plurality of previous workbook version metadata sets, the desired previous workbook version metadata set corresponding to a desired previous workbook version, and restoring by the user interface the desired previous workbook version for display in the active edit display pane of the client device for making changes to the desired previous workbook version at the client device by the user of the system.

In accordance with a further aspect, a non-transitory computer readable medium having instructions thereon is provided for use with a data analytics environment to provide a workbook revision history of changes made to a workbook for use with the data analytics environment. The instructions of the non-transitory computer readable medium, when run and executed cause the computer to perform steps comprising providing a computer including one or more processors, wherein the computer provides access to the data analytics environment.

The instructions of the non-transitory computer readable medium, when run and executed cause the computer to perform further steps comprising providing a revision history handler application running at the data analytics environment, wherein the revision history handler application is configured to store, in a workbook folder of an artifacts catalog of the data analytics environment, a current workbook, current workbook metadata relating to the current workbook, a plurality of previous workbook versions of the current workbook, and a plurality of previous workbook version metadata sets each being related to a corresponding one of the plurality of previous workbook versions of the current workbook;

The instructions of the non-transitory computer readable medium, when run and executed cause the computer to perform further steps comprising providing a user interface running at a client device, wherein the user interface is in operative communication with the revision history handler application;

The instructions of the non-transitory computer readable medium, when run and executed cause the computer to perform further steps comprising providing to the user interface, by the revision history handler application responsive to receiving an initialization request received from the user interface, one or more of the current workbook, the current workbook metadata, and/or the plurality of previous workbook version metadata sets;

The instructions of the non-transitory computer readable medium, when run and executed cause the computer to perform further steps comprising displaying, by the user interface, the current workbook in an active edit display pane of the client device that is configured to receive current workbook change commands for making changes to the current workbook at the client device by a user of the system; and

The instructions of the non-transitory computer readable medium, when run and executed cause the computer to perform further steps comprising displaying in a revision history display pane of the client device, by the user interface, a current version history image based on the current workbook metadata relating to the current workbook displayed in the active edit display pane and a plurality of previous version history images based on the plurality of previous workbook version metadata sets each being related to the corresponding ones of the plurality of previous workbook versions.

In any of the embodiments herein, the instructions of the non-transitory computer readable medium, when run and executed cause the computer to perform further steps comprising providing a version control service running at the client device, the version control service being in operative communication with a cache at the client device, and persisting, by the version control service, one or more of the current workbook, the current workbook metadata, and/or the plurality of previous workbook version metadata sets received from the revision history handler application in the cache at the client device.

In any of the embodiments herein, the instructions of the non-transitory computer readable medium, when run and executed cause the computer to perform further steps comprising receiving by the user interface the current workbook change commands for making the changes to the current workbook at the client device by the user of the system, generating by the user interface based on the changes made to the current workbook an updated workbook and updated workbook metadata related to the updated workbook, displaying by the user interface the updated workbook in the active edit display pane of the client device, and selectively persisting by the version control service in response to a save command received from the user via the active edit display pane the updated workbook and the updated workbook metadata to the cache at the client device.

In any of the embodiments herein, the instructions of the non-transitory computer readable medium, when run and executed cause the computer to perform further steps comprising communicating by the version control service the updated workbook and the updated workbook metadata to the revision history handler application running at the data analytics environment in response to receiving the save command from the user via the active edit display pane, and saving, by the revision history handler application, the updated workbook metadata to a revisions.json file of the workbook folder of the artifacts catalog of the data analytics environment.

In any of the embodiments herein, the instructions of the non-transitory computer readable medium, when run and executed cause the computer to perform further steps comprising receiving by the user interface a reset request from the user, purging by the version control service responsive to the user interface receiving the reset request selected ones of the plurality of previous workbook version metadata sets from the cache at the client device, and persisting to the cache at the client device by the version control service a focused workbook being displayed in the active edit display pane of the client device and focused workbook metadata relating to the focused workbook being displayed in the active edit display pane.

In any of the embodiments herein, the instructions of the non-transitory computer readable medium, when run and executed cause the computer to perform further steps comprising displaying by the user interface the current version history image related to the current workbook metadata in the revision history display pane of the client device in association with a first set of visual indicia indicating to the user of the client device that the current workbook displayed in the active edit display pane of the client device is a Current Revision of the current workbook, and displaying by the user interface the plurality of previous version history images related to the plurality of previous workbook version metadata sets in the revision history display pane of the client device in association with a second set of visual indicia indicating for each of the plurality of previous workbook versions one or more of: a timestamp indicating a time at which that version was saved; an author of that version; a user that modified that version; a user that issued a save command to the version control service relative to that version; and/or a customized name of that version.

In any of the embodiments herein, the instructions of the non-transitory computer readable medium, when run and executed cause the computer to perform further steps comprising receiving by the user interface a desired previous workbook restore request based on the user selecting a desired previous version history image from among the plurality of previous version history images displayed in the revision history display pane of the client device the selected desired previous version history image being related to a desired previous workbook version metadata set from among the plurality of previous workbook version metadata sets, the desired previous workbook version metadata set corresponding to a desired previous workbook version, and restoring by the user interface the desired previous workbook version for display in the active edit display pane of the client device for making changes to the desired previous workbook version at the client device by the user of the system.

In any of the implementations herein, systems and methods are provided for use with a data analytics environment to provide a revision history of workbooks enabling a user to be able to ensure that the versioning system meets compliance requirements by providing detailed logs of changes made to workbooks.

In any of the implementations herein, systems and methods are provided for use with a data analytics environment to provide a revision history of workbooks enabling multiple users to be able to work collaboratively on workbooks by allowing the multiple users to work on a workbook simultaneously without risking data loss or conflicts.

In any of the implementations herein, systems and methods are provided for use with a data analytics environment, wherein the systems and methods automatically create a new version of a workbook whenever author saves the changes on the workbook.

In any of the implementations herein, systems and methods are provided for use with a data analytics environment to provide a revision history of workbooks enabling a user to be able to view a list of all versions of a workbook.

In any of the implementations herein, systems and methods are provided for use with a data analytics environment, wherein the systems and methods automatically display metadata for each version, including the timestamp of creation and the user who made the changes.

In any of the implementations herein, systems and methods are provided for use with a data analytics environment to provide a revision history of workbooks enabling a user to be able to restore a previous version of a workbook with a single click input to the system.

In any of the implementations herein, systems and methods are provided for use with a data analytics environment, wherein the systems and methods automatically, when restoring a previous version of a workbook, create a new version of the workbook based on the restored workbook.

In any of the implementations herein, systems and methods are provided for use with a data analytics environment to provide a revision history of workbooks enabling a user to be able to turn on/off or otherwise enable/disable versioning on a workbook.

In any of the implementations herein, systems and methods are provided for use with a data analytics environment to provide a revision history of workbooks enabling a user to be able to name or label workbook versions for easy intuitive identification of the workbook versions.

### Brief Description of the Drawings:

FIG. 1 illustrates a system for providing a cloud infrastructure or data analytics environment, in accordance with an embodiment.

FIG. 2 further illustrates a system for providing a cloud infrastructure or data analytics environment, in accordance with an embodiment.

FIG. 3 illustrates an example use of the system to provide a data analytics environment, in accordance with an embodiment.

FIG. 4 further illustrates an example data analytics environment, in accordance with an embodiment.

FIG. 5 further illustrates an example data analytics environment, in accordance with an embodiment.

FIG. 6 further illustrates an example data analytics environment, in accordance with an embodiment.

FIG. 7 further illustrates an example data analytics environment, in accordance with an embodiment.

FIG. 8 further illustrates an example data analytics environment, in accordance with an embodiment.

FIG. 9 further illustrates an example data analytics environment, including the use of a large language model, in accordance with an embodiment.

FIG. 10 further illustrates an example data analytics environment, including the use of retrieval-augmented generation, in accordance with an embodiment.

FIG. 11 illustrates a system for use with a data analytics environment to provide a revision history for use with a data analytics environment, in accordance with an embodiment.

FIG. 12 illustrates a screenshot produced by a system to provide a revision history for use with a data analytics environment, in accordance with an embodiment.

FIG. 13 illustrates a screenshot produced by a system to provide a revision history for use with a data analytics environment, in accordance with an embodiment.

FIG. 14 illustrates a screenshot produced by a system to provide a revision history for use with a data analytics environment, in accordance with an embodiment.

FIG. 15 illustrates a screenshot produced by a system to provide a revision history for use with a data analytics environment, in accordance with an embodiment.

FIG. 16 illustrates a screenshot produced by a system to provide a revision history for use with a data analytics environment, in accordance with an embodiment.

FIG. 17 illustrates a screenshot produced by a system to provide a revision history for use with a data analytics environment, in accordance with an embodiment.

FIG. 18 illustrates a screenshot produced by a system to provide a revision history for use with a data analytics environment, in accordance with an embodiment.

FIG. 19 illustrates a screenshot produced by a system to provide a revision history for use with a data analytics environment, in accordance with an embodiment.

FIG. 20 illustrates a screenshot produced by a system to provide a revision history for use with a data analytics environment, in accordance with an embodiment.

FIG. 21 illustrates a screenshot produced by a system to provide a revision history for use with a data analytics environment, in accordance with an embodiment.

FIG. 22 illustrates a screenshot produced by a system to provide a revision history for use with a data analytics environment, in accordance with an embodiment.

FIG. 23 illustrates a flowchart of a method for use with a data analytics environment to provide a revision history for use with a data analytics environment, in accordance with an embodiment.

### Detailed Description:

Generally described, within an organization, data analytics enables computer-based examination of large amounts of data, for example to derive conclusions or other information from the data. For example, business intelligence (BI) tools can be used to provide users with business intelligence describing their enterprise data, in a format that enables the users to make strategic business decisions.

Increasingly, data analytics can be provided within the context of enterprise software application environments, such as, for example, an Oracle Fusion Applications environment; or within the context of software-as-a-service (SaaS) or cloud environments, such as, for example, an Oracle Analytics Cloud or Oracle Cloud Infrastructure environment; or other types of analytics application or cloud environments.

Examples of data analytics environments and business intelligence tools/servers include Oracle Business Intelligence Server (OBIS), Oracle Analytics Cloud (OAC), and Fusion Analytics Warehouse (FAW), which support features such as data mining or analytics, and analytic applications.

### Cloud Infrastructure Environments

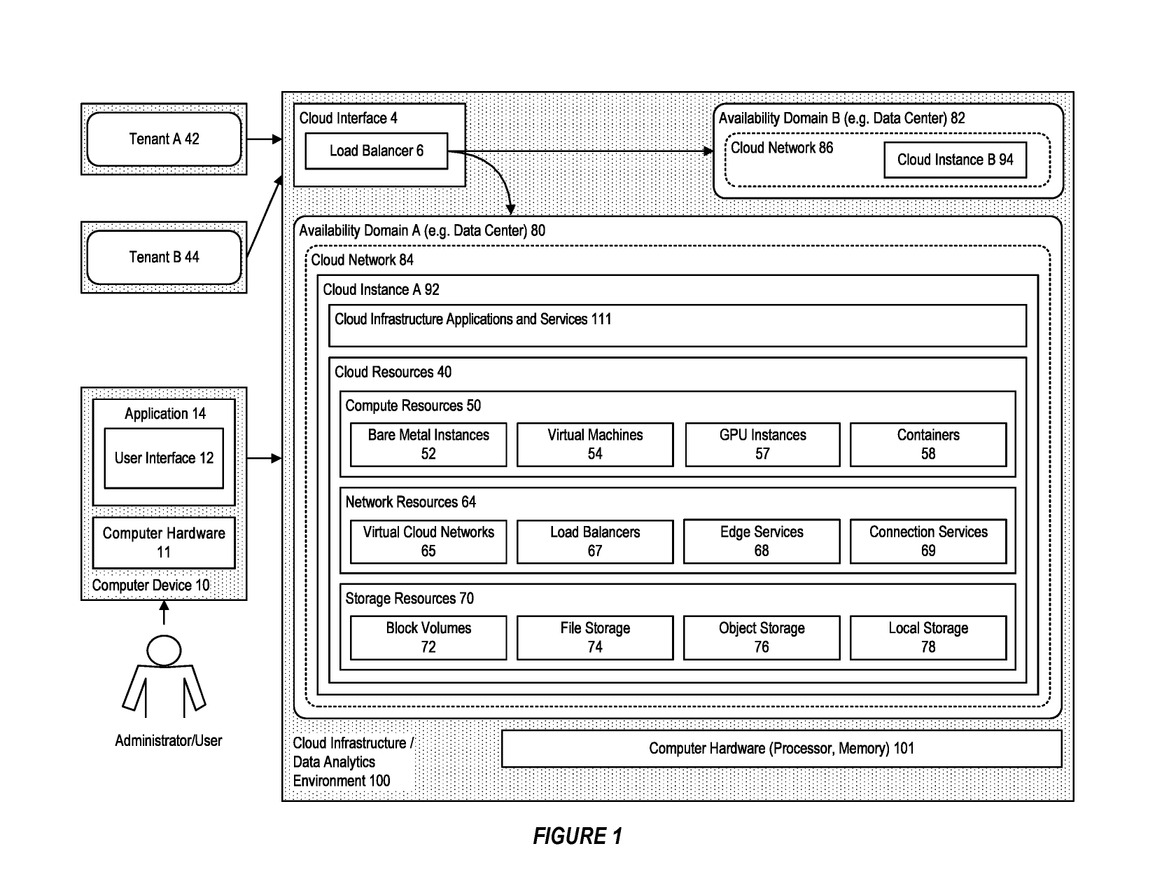

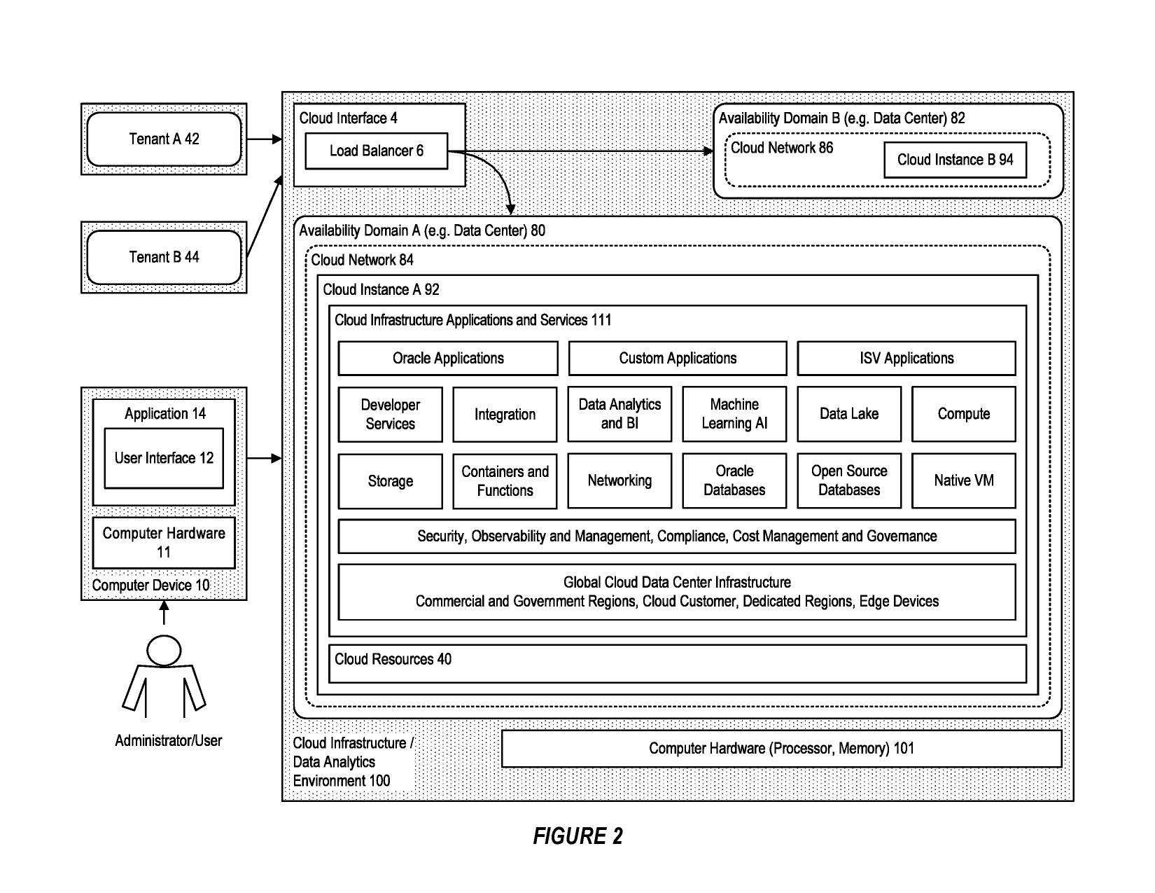

FIGS. 1 and 2 illustrate a system for providing a cloud infrastructure or data analytics environment, in accordance with an embodiment.

In accordance with an embodiment, the components and processes illustrated in FIG. 1, and as further described herein with regard to various embodiments, can be provided as software or program code executable by a computer system or other type of processing device, for example a cloud computing system, or other suitably-programmed computer system.

The illustrated example is provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud infrastructure or data analytics environment 100 can operate on a cloud computing infrastructure 101 comprising hardware (e.g., processor, memory), software resources, and one or more cloud interfaces 4 or other application program interfaces (API) that provide access to the shared cloud resources via one or more load balancers 6.

In accordance with an embodiment, the cloud infrastructure environment supports the use of availability domains, such as, for example, availability domains A 80, B 82, which enables customers to create and access cloud networks 84, 86, and run cloud instances A 92, B 94.

In accordance with an embodiment, a tenancy can be created for each cloud tenant/customer, for example tenant A 42, B 44, which provides a secure and isolated partition within the cloud infrastructure environment within which the customer can create, organize, and administer their cloud resources. A cloud tenant/customer can access an availability domain and a cloud network to access each of their cloud instances.

In accordance with an embodiment, a client device, such as, for example, a computing device 10 having a device hardware 11 (e.g., processor, memory), application 14 and graphical user interface 12, can enable an administrator other user to communicate with the cloud infrastructure environment via a network such as, for example, a wide area network, local area network, or the Internet, to create or update cloud services.

In accordance with an embodiment, the cloud infrastructure environment provides access to shared cloud resources 40 via, for example, a compute resources layer 50, a network resources layer 64, and/or a storage resources layer 70. Customers can launch cloud instances as needed, to meet compute and application requirements. After a customer provisions and launches a cloud instance, the provisioned cloud instance can be accessed from, for example, a client device.

In accordance with an embodiment, the compute resources layer can comprise resources, such as, for example, bare metal cloud instances 52, virtual machines 54, graphical processing unit (GPU) compute cloud instances 57, and/or containers 58. The compute resources layer can be used to, for example, provision and manage bare metal compute cloud instances, or provision cloud instances as needed to deploy and run applications, as in an on-premises data center.

For example, in accordance with an embodiment, the cloud infrastructure environment can provide control of physical host (bare metal) machines within the compute resources layer, which run as compute cloud instances directly on bare metal servers, without a hypervisor.

In accordance with an embodiment, the cloud infrastructure environment can also provide control of virtual machines within the compute resources layer, which can be launched, for example, from an image, wherein the types and quantities of resources available to a virtual machine cloud instance can be determined, for example, based upon the image that the virtual machine was launched from.

In accordance with an embodiment, the network resources layer can comprise a number of network-related resources, such as, for example, virtual cloud networks (VCNs) 65, load balancers 67, edge services 68, and/or connection services 69.

In accordance with an embodiment, the storage resources layer can comprise a number of resources, such as, for example, data/block volumes 72, file storage 74, object storage 76, and/or local storage 78.

In accordance with an embodiment, the cloud environment can include a container orchestration system, and container orchestration system API, that enables containerized application workflows to be deployed to a container orchestration environment, for example a Kubernetes (k8s) cluster.

For example, in accordance with an embodiment, the cloud environment can be used to provide containerized compute cloud instances within the compute resources layer, and a container orchestration implementation (e.g., Oracle Cloud Infrastructure Container Engine for Kubernetes (OKE)), can be used to build and launch containerized applications or cloud-native applications, specify compute resources that the containerized application requires, and provision the required compute resources.

As illustrated in FIG. 2, in accordance with an embodiment, the cloud infrastructure or data analytics environment can include a range of complementary cloud-based components, for example as cloud infrastructure applications and services 111, that enable organizations or enterprise customers to operate their applications and services in a highly-available hosted environment.

By way of example, in accordance with an embodiment, a self-contained cloud region can be provided as a complete, e.g., Oracle Cloud Infrastructure (OCI) dedicated region within an organization’s data center that offers the data center operator the agility, scalability, and economics of a public cloud, while retaining full control of their data and applications to meet security, regulatory, or data residency requirements.

### Data Analytics Environments

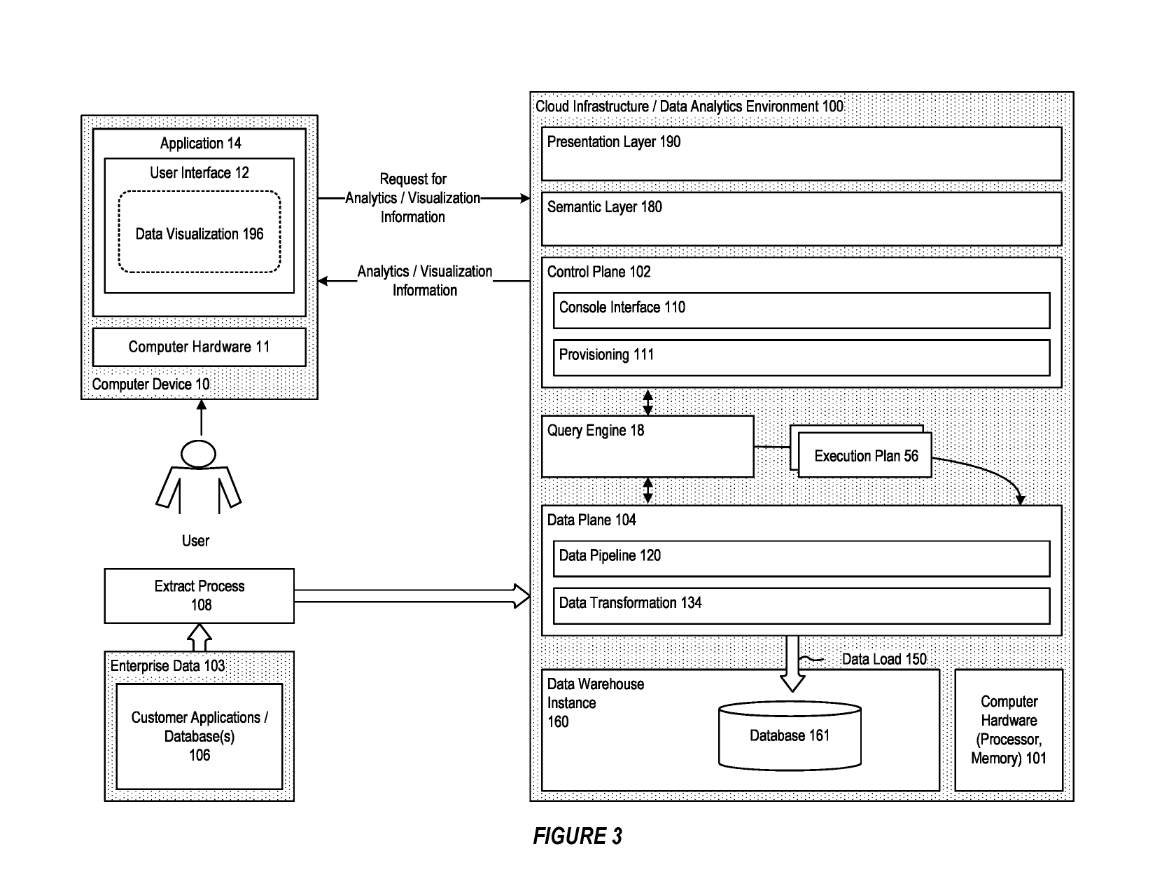

FIG. 3 illustrates an example use of the system to provide a data analytics environment, in accordance with an embodiment.

The example embodiment illustrated in FIG. 3 is provided for purposes of illustrating an example of a data analytics environment in association with which various embodiments described herein can be used. In accordance with other embodiments and examples, the approach described herein can be used with other types of data analytics, database, or data warehouse environments.

As illustrated in FIG. 3, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access in the manner of a data layer 270 to a data warehouse instance 160 (e.g., having a database 161, or other type of data source).

In accordance with an embodiment, the control plane operates to provide control for cloud or other software products offered within the context of a cloud environment. For example, in accordance with an embodiment, the control plane can include a console interface 110 that enables access by a customer (tenant) and/or a cloud environment having a provisioning component 111, for example to allow customers to provision services for use within their enterprise environment. The provisioning component can provision a data warehouse instance, including a customer schema of the data warehouse; and populate the data warehouse instance with the appropriate information supplied by the customer.

In accordance with an embodiment, the data plane can include a data pipeline or process layer 120 and a data transformation layer 134, that together process data from an organization’s enterprise software environment, and load a transformed data into the data warehouse. The data transformation layer can include a data model, such as, for example, a knowledge model (KM), or other type of data model, that the system uses to transform the data received from business applications and corresponding databases, into a model format understood by the data analytics environment. The data plane is responsible for performing extract, transform, and load (ETL) operations, including extracting data from an organization’s enterprise software environment, transforming the extracted data into a model format, and loading the transformed data into a customer schema of the data warehouse.

For example, in accordance with an embodiment, each customer (tenant) of the environment can be associated with their own customer schema; and can be additionally provided with read-only access to the data analytics schema, which can be updated by a data pipeline or process, for example, an ETL process, on a periodic or other basis. For example, a data pipeline or process can be scheduled to execute at intervals (e.g., hourly/daily/weekly) to extract enterprise data 103 from an enterprise software environment, such as, for example, business productivity software applications and corresponding databases 106.

In accordance with an embodiment, an extract process 108 can extract the data, whereupon extraction the data pipeline or process can insert extracted data into a data staging area, which can act as a temporary staging area for the extracted data. When the extract process has completed its extraction, the data transformation layer can be used to transform the extracted data into a model format to be loaded into the customer schema of the data warehouse. During the data transformation, the system can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150, to load the transformed data into the customer schema of the data warehouse instance. Subsequent to the loading of the transformed data into customer schema, the transformed data can be analyzed and used in a variety of additional business intelligence processes.

Different customers may have different requirements with regard to how their data is classified, aggregated, or transformed, for providing data analytics or business intelligence data, or developing software analytic applications. In accordance with an embodiment, to support such different requirements, a semantic layer 180 can include data defining a semantic model of a customer’s data; which is useful in assisting users in understanding and accessing that data using commonly-understood business terms; and provide custom content to a presentation layer 190.

In accordance with an embodiment, a customer may perform modifications to their data source model, to support their particular requirements, for example by adding custom facts or dimensions associated with the data stored in their data warehouse instance; and the system can extend the semantic model accordingly. A semantic model can be defined, for example, in an Oracle environment, as a BI Repository (RPD) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, the presentation layer can enable access to the data content using, for example, a software analytic application, user interface, analytics dashboard, key performance indicators (KPI’s); or other type of report or interface as may be provided by products such as, for example, Oracle Analytics Cloud, or Oracle Analytics for Applications.

In accordance with an embodiment, a query engine 18 (e.g., an Oracle Business Intelligence Server, OBIS instance) operates in the manner of a federated query engine to serve analytical queries or requests from clients directed to data stored at a database. The query engine can push down operations to supported databases, in accordance with a query execution plan 56, wherein a logical query can include Structured Query Language (SQL) statements received from the clients; while a physical query includes database-specific statements that the query engine sends to the database to retrieve data when processing the logical query.

In accordance with an embodiment, a user/developer can interact with a client computer device 10 that includes a computer hardware 11 (e.g., processor, storage, memory), user interface 12, and client application 14. A query engine or business intelligence server generally operates to process inbound, e.g., SQL, requests against a database model, build and execute one or more physical database queries, process the data appropriately, and return the data in response to the request.

To accomplish this, in accordance with an embodiment, the query engine can include a logical or business model, or metadata, that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, the query engine may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine can process queries against a database according to a query execution plan. During operation the query engine can create a query execution plan which can then be further optimized, for example to perform aggregations of data necessary to respond to a request. Data can be combined together and further calculations applied, before the results are returned to the calling application.

In accordance with an embodiment, a request for data analytics or visualization information can be received via a client application and user interface as described above, and communicated to the data analytics environment (in the example of a cloud environment, via a cloud service). The system can retrieve an appropriate dataset to address the user/business context, for use in generating and returning the requested data analytics or visualization information to the client, as a data visualization 196.

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the data analytics environment, or in the example of a cloud environment via a cloud service provided by the environment.

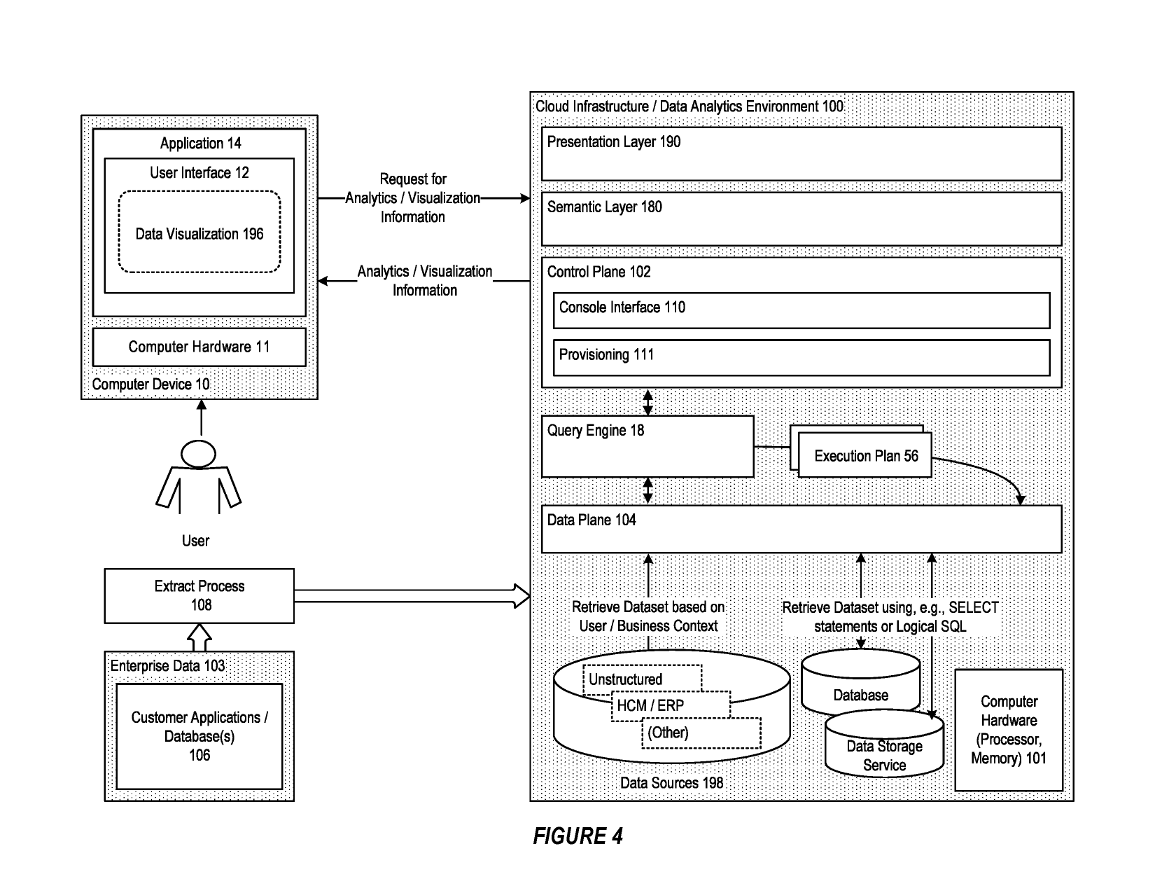

FIG. 4 further illustrates an example data analytics environment, in accordance with an embodiment.

As illustrated in FIG. 4, in accordance with an embodiment, the data analytics environment enables a dataset to be retrieved, received, or prepared from one or more data source(s) 198, for example via one or more data source connections. Examples of the types of data that can be transformed, analyzed, or visualized using the systems and methods described herein include data directed to Enterprise Resource Planning (ERP), Human Capital Management (HCM), or Human Resources (HR), or other types of data provided at one or more of a database, data storage service, or other type of data repository or data source.

For example, in accordance with an embodiment, a request for data analytics or visualization information can be received via a client application and user interface as described above, and communicated to the data analytics environment, for example via a cloud service. The system can retrieve an appropriate dataset to address the user/business context, for use in generating and returning the requested data analytics or visualization information to the client.

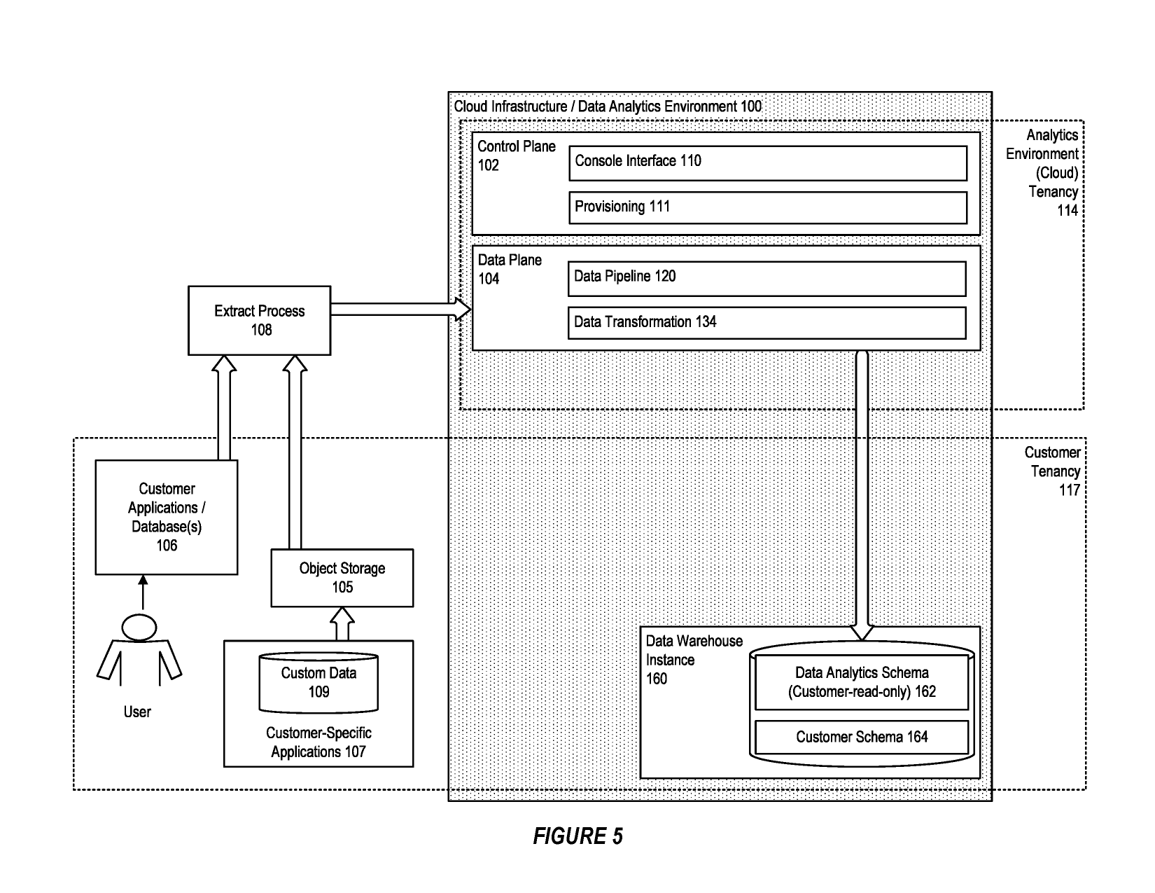

FIG. 5 further illustrates an example data analytics environment, in accordance with an embodiment.

As illustrated in FIG. 5, in accordance with an embodiment, data can be sourced, e.g., from a customer’s (tenant’s) enterprise software environment (106), using the data pipeline process; or as custom data 109 sourced from one or more customer-specific applications 107; and loaded to a data warehouse instance, including in some examples the use of an object storage 105 for storage of the data. A user can create a dataset that uses tables from different connections and schemas. The system uses the relationships defined between these tables to create relationships or joins in the dataset.

In accordance with an embodiment, the data warehouse can include a default data analytics schema 162 and, for each customer (tenant) of the system, a customer schema 164. For each customer (tenant), the system uses the data analytics schema that is maintained and updated by the system, within a system/cloud tenancy 114, to pre-populate a data warehouse instance for the customer, based on an analysis of the data within that customer’s enterprise applications environment, and within a customer tenancy 117. As such, the data analytics schema maintained by the system enables data to be retrieved, by the data pipeline or process, from the customer’s environment, and loaded to the customer’s data warehouse instance.

In accordance with an embodiment, the system also provides, for each customer of the environment, a customer schema that allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse can include a data analytics schema and, for each customer/tenant, a customer schema sourced from their enterprise software environment. The data provisioned in a data warehouse tenancy is accessible only to that tenant; while at the same time allowing access to various, e.g., ETL-related or other features of the shared environment.

In accordance with an embodiment, for a particular customer/tenant, upon extraction of their data, the data pipeline or process can insert the extracted data into a data staging area for the tenant, which can act as a temporary staging area for the extracted data. When the extract process has completed its extraction, the data transformation layer can be used to transform the extracted data into a model format to be loaded into the customer schema of the data warehouse.

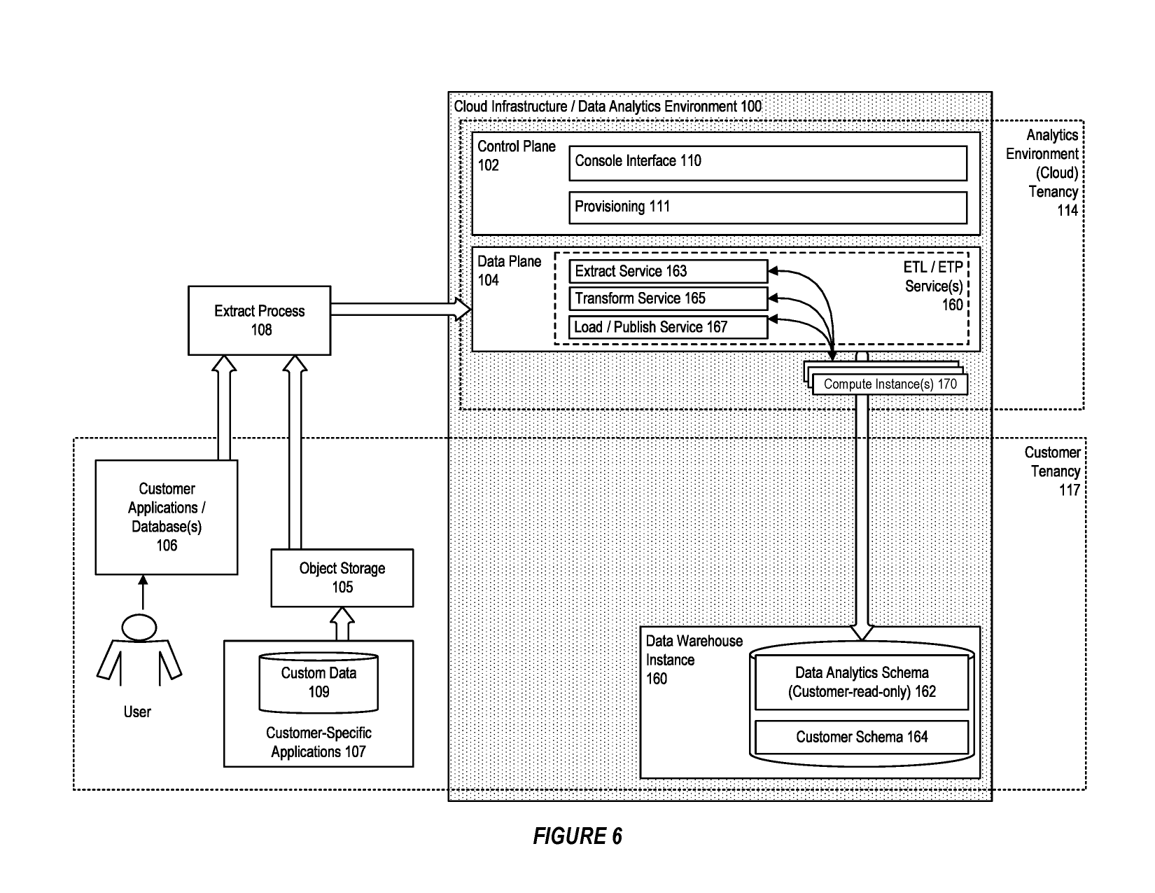

FIG. 6 further illustrates an example data analytics environment, in accordance with an embodiment.

As illustrated in FIG. 6, in accordance with an embodiment, the process of extracting data from a customer’s (tenant’s) enterprise software environment, and loading the data to a data warehouse instance, or refreshing the data in a data warehouse, generally involves several stages, performed by an ETP service 160 or process, including one or more extraction service 163; transformation service 165; and load/publish service 167, executed by one or more compute instance(s) 170.

For example, in accordance with an embodiment, extracted files can be uploaded to an object storage component for storage of the data. The transformation process then applies a business logic while loading them to a target data warehouse, e.g., an Autonomous Data Warehouse (ADW) database, which is internal to the data pipeline or process, and is not exposed to the customer (tenant). A load/publish service or process takes the data from the ADW database and publishes it to a data warehouse instance that is accessible to the customer (tenant).

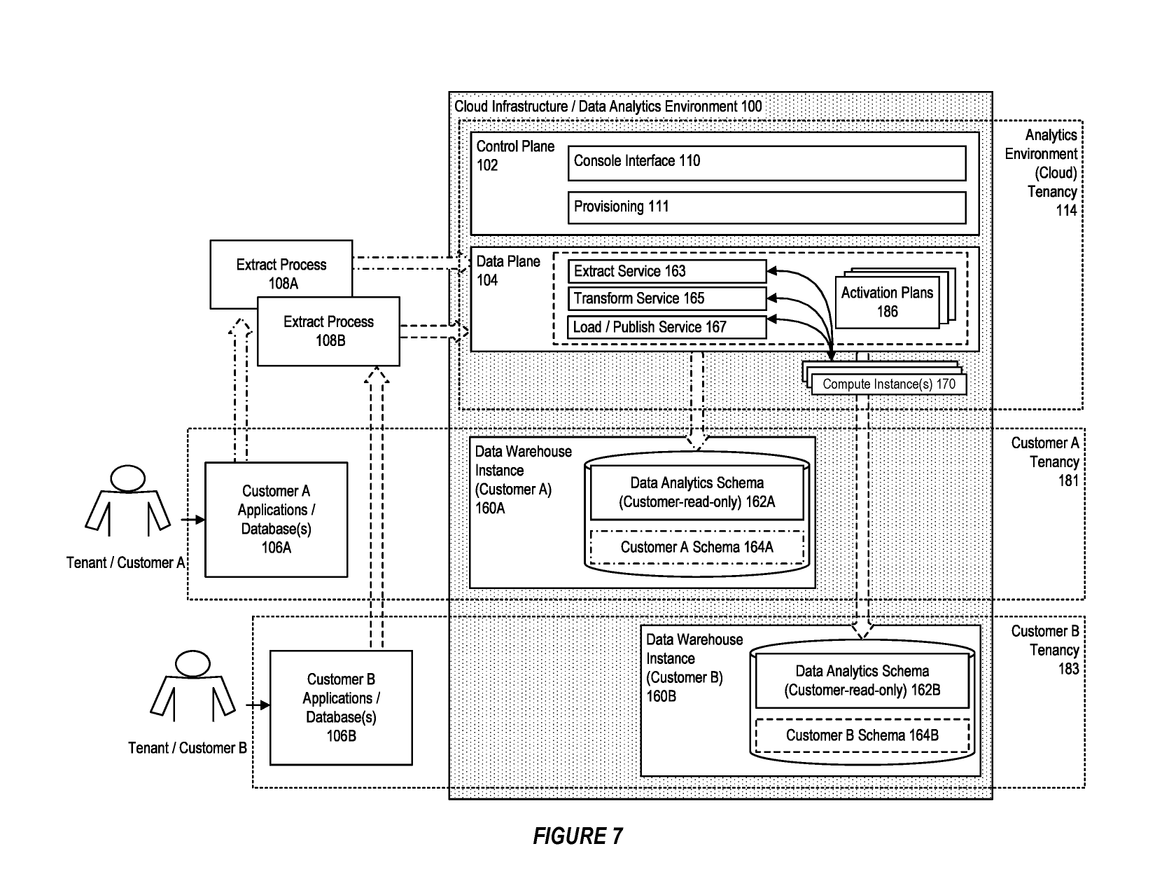

FIG. 7 further illustrates an example data analytics environment, in accordance with an embodiment.

As illustrated in FIG. 7, in accordance with an embodiment, the data pipeline or process maintains, for each of a plurality of customers (tenants), for example customer A 180, customer B 182, a data analytics schema that is updated on a periodic basis, by the system in accordance with best practices for a particular analytics use case. For each of a plurality of customers (e.g., customers A, B), the system uses the data analytics schema 162A, 162B, that is maintained and updated by the system, to pre-populate a data warehouse instance for the customer, based on an analysis of the data within that customer’s enterprise applications environment 106A, 106B, and within each customer’s tenancy (e.g., customer A tenancy 181, customer B tenancy 183); so that data is retrieved, by the data pipeline or process, from the customer’s environment, and loaded to the customer’s data warehouse instance 160A, 160B.

In accordance with an embodiment, the data analytics environment also provides, for each of a plurality of customers of the environment, a customer schema (e.g., customer A schema 164A, customer B schema 164B) that allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to transform the extracted data into a model format to be loaded into the customer schema of the data warehouse.

In accordance with an embodiment, activation plans 186 can be used to control the operation of the data pipeline or process services for a customer, for a particular functional area, to address that customer’s (tenant’s) particular needs. For example, an activation plan can define a number of extract, transform, and load (publish) services or steps to be run in a certain order, at a certain time of day, and within a certain window of time.

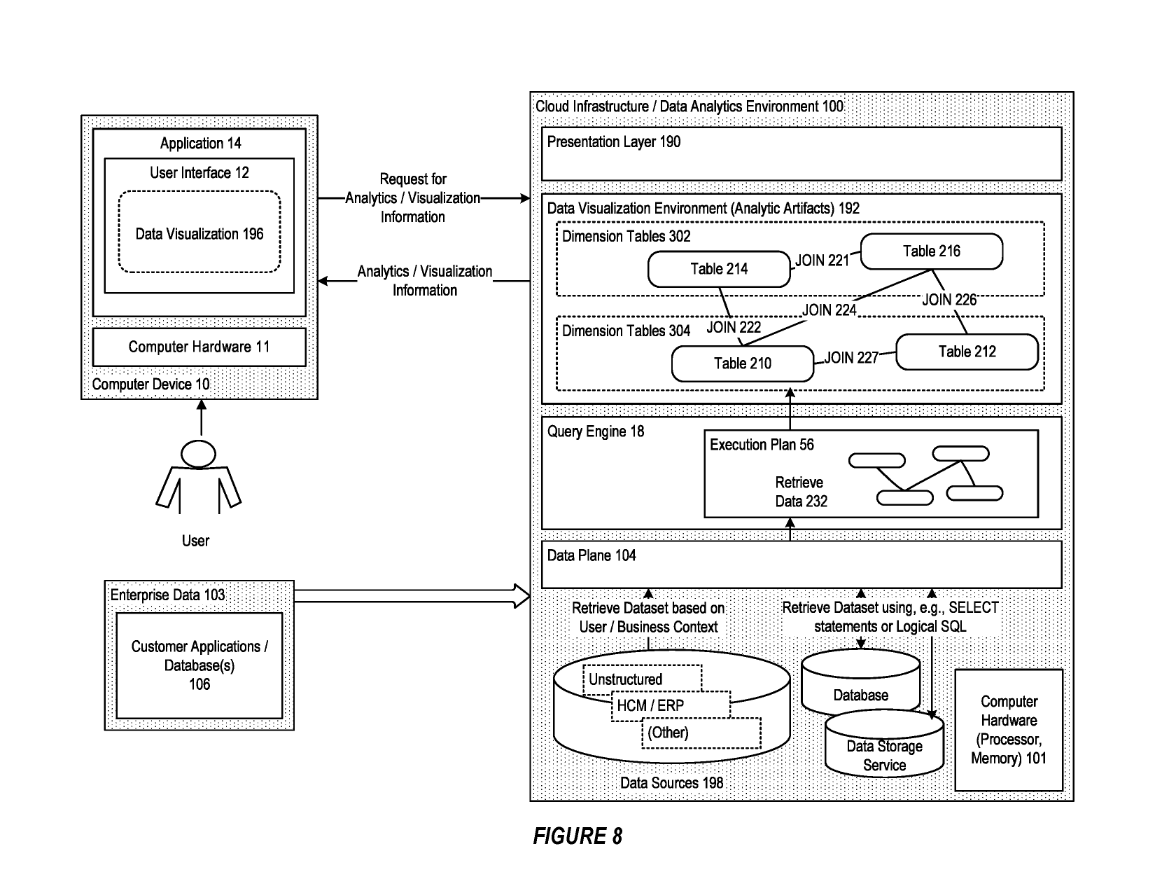

FIG. 8 further illustrates an example data analytics environment, in accordance with an embodiment.

Generally described, within a database or data warehouse, the data of interest may be spread across multiple tables. In such environments, joins can be used to stitch the data from various tables together, to better prepare the data for analysis.

For example, as illustrated in FIG. 8, in accordance with an embodiment, the data analytics environment enables a dataset to be retrieved, received, or prepared from one or more data source(s), for example via one or more data source connections, fact and/or dimension tables 210-216, or joins 221-227 between selections of dimension tables 302, 304.

In accordance with an embodiment, a request received at a data visualization environment to display analytic artifacts 192, for example as may be related to key performance indicators, analytics dashboards, or scorecards, can be received via a client application and user interface as described above, and communicated to the data analytics environment via a cloud service. The system can retrieve 232 an appropriate dataset using, e.g., SELECT statements, to address the user/business context, for use in generating and returning the requested data analytics or visualization information to the client.

### Large Language Models (LLM)

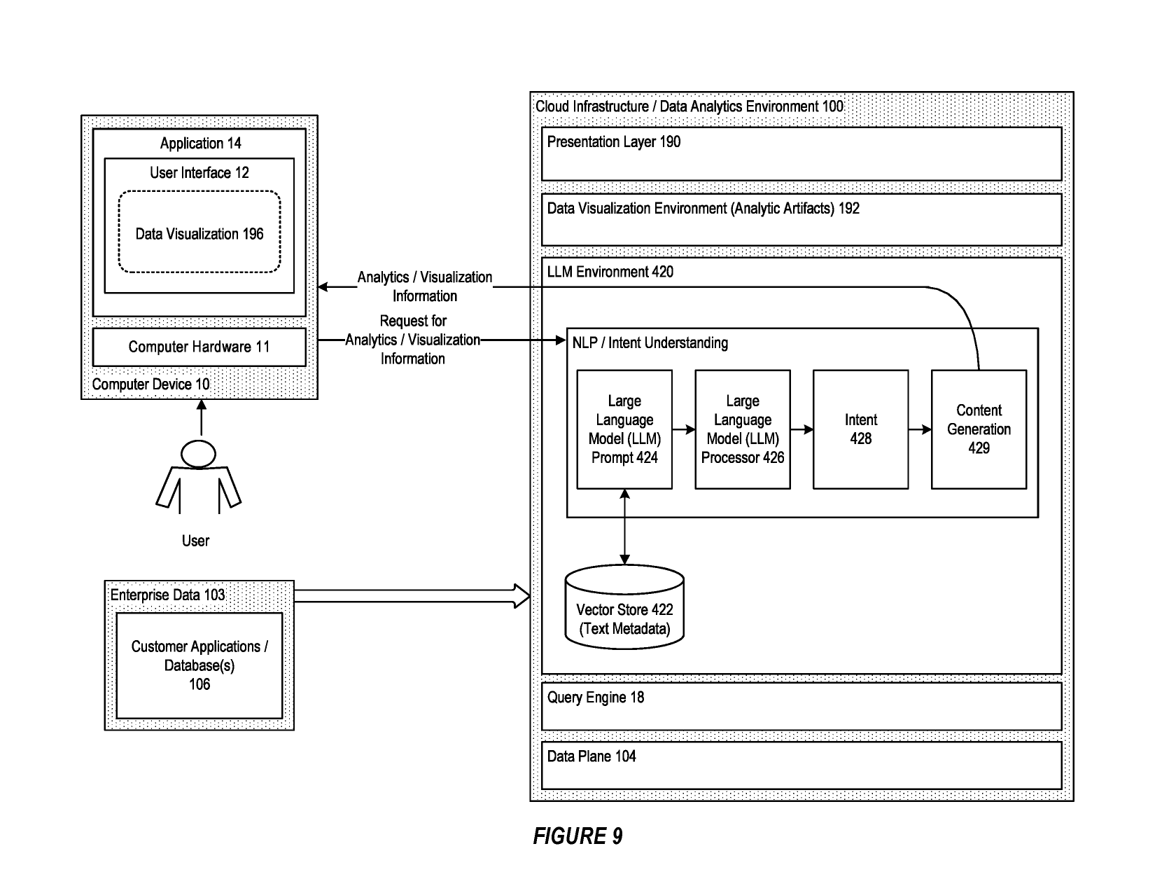

FIG. 9 further illustrates an example data analytics environment, including the use of a large language model, in accordance with an embodiment.

As illustrated in FIG. 9, in accordance with an embodiment, a data analytics system can include a large language model (LLM) environment 420. A vector database 422 provides storage and retrieval of vectors or vector embeddings, which in turn enables LLMs to understand information with increased context and accuracy, for example in generating a requested data analytics information or data visualization.

In accordance with an embodiment, the system can parse a user query or natural language input, infer an intent 428 based on one or more large language model (LLM) prompt 424 or LLM processor 426, and then determine, for example, which subject areas may be relevant to the inferred intent, and generate or return an appropriate content 429.

### Retrieval-Augmented Generation (RAG)

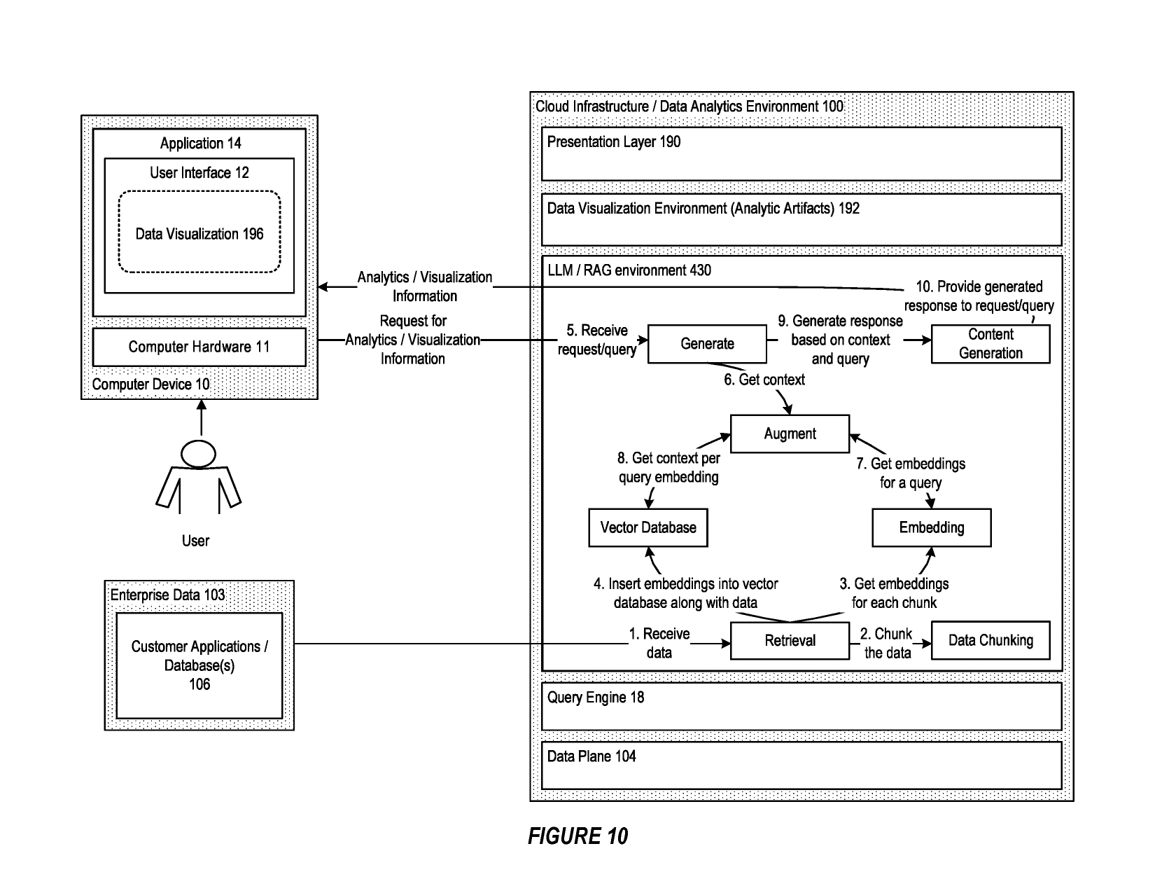

FIG. 10 further illustrates an example data analytics environment, including the use of retrieval-augmented generation, in accordance with an embodiment.

As illustrated in FIG. 10, in accordance with an embodiment, a data analytics system can include the use of retrieval-augmented generation (RAG) environment 430 that optimizes the output of a large language model (LLM) with targeted information, to provide a more contextually appropriate content in response to a user query.

In accordance with an embodiment, during the retrieval process::

Enterprise data can be received (1) in various formats, for example, as PDF, TXT, CSV, XML, or JSON documents, via REST, File, or other protocols.

The enterprise data or documents is broken into a plurality of segment or chunks (2).

Vector embeddings are obtained for each chunk of data (3), for example by calling a generative AI embedding service, or by using an embedding model.

The vector embeddings associated with the chunks of data are stored in a vector database, along with the data (4).

In accordance with an embodiment, during the augmented generation process:

The system can receive from a user, a data request or query, or a natural language input (5).

The system invokes an augmentation process or service to obtain the context for the request or query (6).

An embedding service is used to get the vector embeddings of the query data (7).

The augmentation process or service can obtain additional context based on a semantic search of the query data and its vector embedding (8).

The system can then generate an appropriate response based on the context and query (9); and return the generated response to the user (10).

The above example is provided for purpose of illustrating an example of a data analytics environment that includes the use of retrieval-augmented generation. In accordance with other embodiments, the system can include other forms of retrieval-augmented generation, which in turn can include different or other components or processes.

### Revision History in a Data Analytics Environment

In accordance with an embodiment, data analytics environments, such as Oracle Analytics Cloud, allow users to create workbooks. However, one significant limitation of the current platform is the lack of versioning capability. The absence presents several challenges for users and administrators, including data loss, difficulty in tracking changes, and potential conflicts during collaborative work. However, this is not only a user-specific problem, as support teams need to diagnose the customer issues without having a look at prior versions of the metadata.

In accordance with example embodiments, systems and methods provide a versioning feature in the form of a revision history for workbooks in various data analytics environments and on or in various business intelligence tools/servers including for example Oracle Business Intelligence Server (OBIS), Oracle Analytics Cloud (OAC), Fusion Analytics Warehouse (FAW), and the like, that support features such as data mining or analytics. As used herein, “workbook” includes but is not limited to OAC Workbooks.

The systems and methods herein enable workbook authors and other system users to track all the changes that have been made to a workbook. The systems and methods herein further enable workbook authors and other system users to view in the form of a revision history all the changes that have been made to a workbook. In addition, the systems and methods herein still further enable workbook authors and other system users to restore a workbook to a selected previous version of the workbook.

The above features of the subject systems and methods for providing a revision history enable workbook authors and other system users to collaborate more efficiently in generating or otherwise creating workbooks, and further to be able to track and audit changes that were made chronologically to workbooks.

In accordance with an embodiment, a catalog is provided in the data analytics environment such as in the OAC data analytics environment, for example. By taking advantage of this catalog that is provided in the example embodiment, the systems and methods can persist multiple artifacts created in the data analytics environment such as in the OAC data analytics environment including persisting the workbook in a workbook folder and metadata corresponding to different revisions of the workbook within the workbook’s folder. Advantageously therefore, each and every one or more of the various versions of a workbook are able to be exported along with the workbook itself and they are also advantageously also able to be accessed within that workbook. Then, the systems and methods can restore the workbook’s metadata based on the contents of a file, such as a revisions.json file. In an example implementation, the revisions.json file can only be seen by admin users.

In accordance with an embodiment, this revision history affects the workbook metadata and allows to rollback or re-apply the state of filters, parameters, changes to the presentation curated experience, visualizations, etc. by selecting a revision in the special revision mode.

In accordance with an embodiment, the systems and methods allows author users to decide whether to enable the revision history functionality, or disable the revision history functionality based on a workbook-level setting.

In accordance with an embodiment, this revision history can assist by allowing users to overcome the potential issues with data loss, tracking changes, and the conflicts caused by collaborative work. While providing an in-house solution that doesn’t rely on external software, such as external version control systems.

In accordance with an embodiment, the systems and methods provide users the flexibility to decide whether to allow or otherwise enable the revision history on a workbook or not. The systems and methods are contained within one system and do not rely on external version control. The revision history allows not only to roll back the actual content, but also to restore filters, layouts, visualizations, and other configurations. The systems and methods enhance support team capabilities by providing access to metadata differences between revisions, helping them to diagnose customer issues faster.

The systems and methods herein enable workbook authors and other system users to track all the changes that have been made to a workbook. The systems and methods herein further enable workbook authors and other system users to view in the form of a revision history all the changes that have been made to a workbook. In addition, the systems and methods herein still further enable workbook authors and other system users to restore a workbook to a selected previous version of the workbook.

The systems and methods herein enable multiple workbook authors or users that have edit privileges to be able to make changes to a workbook that they are collaborating on. Any of the one or more users or authors may enable or disable the revision history or version tracking functionality as desired.

Workbook changes may include but are not limited to updates made to the workbook, edits made to the workbook, and/or deletions made to the workbook. When the revision history functionality is enabled by the one or more users or authors of the workbook, each and every of the changes made to the workbook, including the updates, edits and/or deletions made to the workbook changes may include but are not limited to updates made to the workbook, edits made to the workbook, and/or deletions made to the workbook.

In accordance with an embodiment, the revision history functionality is enabled by the one or more users or authors of the workbook launching a revision history user interface (UI).

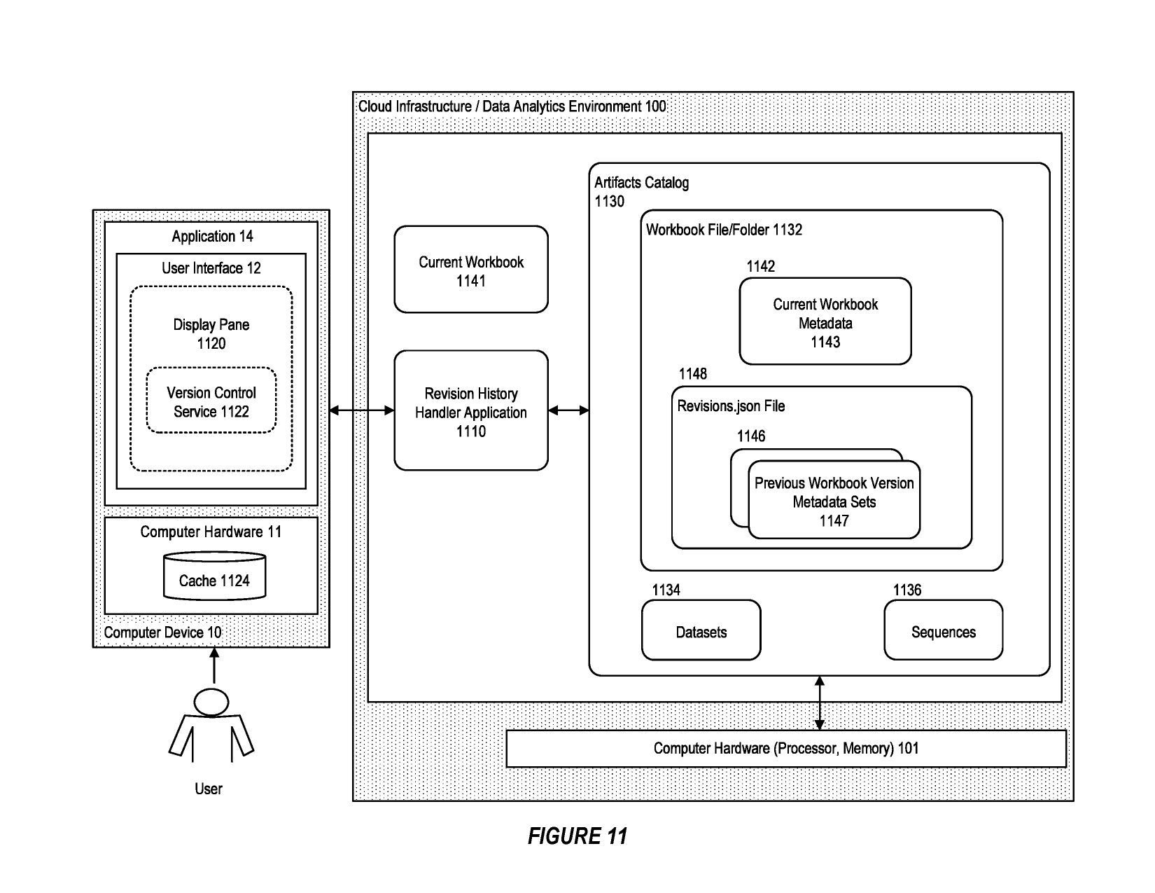

FIG. 11 illustrates a system providing a revision history for use with a data analytics environment, in accordance with an embodiment.

In accordance with an embodiment, a cloud infrastructure or data analytics environment 100 can operate on a cloud computing infrastructure 101 comprising hardware (e.g., processor, memory), software resources, and one or more cloud interfaces or other application program interfaces (API) that provide access to the shared cloud resources via one or more load balancers.

In accordance with an embodiment, a client device, such as, for example, a computing device 10 having a device hardware 11 (e.g., processor, memory), application 14 and user interface 12, such as a graphical user interface, can enable an administrator other user to communicate with the cloud infrastructure environment via a network such as, for example, a wide area network, local area network, or the Internet, to create, utilize or update cloud services.

In accordance with an embodiment, a revision history handler application 1110 can be provided within the cloud infrastructure/data analytics environment 100. The revision history handler application 1110, which when accessed by, for example, the computer device 100 can provide at the client device 10, a chat, text, or other type of user interface or display pane 1120 which a user can interact with and/or provide inputs or receive outputs from.

In accordance with the example embodiment illustrated, the system 1100 provides a workbook revision history of changes made to a workbook 1141 for use with the data analytics environment 100. The system 1100 comprises the computer 10 as described herein including one or more processors wherein the computer provides access to the data analytics environment 100. The system 1100 further comprises the revision history handler application 1110, and the user interface 1120 running at the client device 10, wherein the user interface 1120 is in operative communication with the revision history handler application 1100.

In accordance with the example embodiment illustrated, the revision history handler application 1110 is configured to store various items including workbook metadata 1143, 1147 related to the workbook 1141 in a workbook folder 1132 of an artifacts catalog 1130 of the data analytics environment 100. The data analytics environment 100 of the system 1100 illustrated allows users to create multiple artifacts such as workbooks, datasets, sequences, and the like. In accordance with the example, any workbook that is generated may be stored relative to the general workbook file or folder 1132, any datasets that are generated may be stored in a datasets file or folder 1134, and any sequences that are generated may be stored in a sequences file or folder 1136.

In accordance with the example embodiment illustrated, the subject workbook revision history system 1100 including and without limitation the workbook folder 1132 being stored in the artifacts catalog 1130 helps to prevent loss of valuable insights and analysis of the multiple artifacts such the workbooks, datasets, sequences, and the like that may be caused by accidental changes, deletions, or the like.

The workbook folder 1132 of the artifacts catalog 1130 of the system 1100 in the data analytics environment 100 may store current workbook metadata 1143 relating to the current workbook 1141 in one or more current workbook metadata files or folders 1142. The workbook folder 1132 of the artifacts catalog 1130 of the system 1100 may still further store a plurality of previous workbook version metadata sets 1147 each being related to a corresponding one of a plurality of previous workbook versions of the current workbook 1141 in one or more previous workbook version metadata set files or folders 1146. The plurality of previous workbook version metadata sets 1147 may be stored in a revisions.json file 1148 in a versioned way, for example.

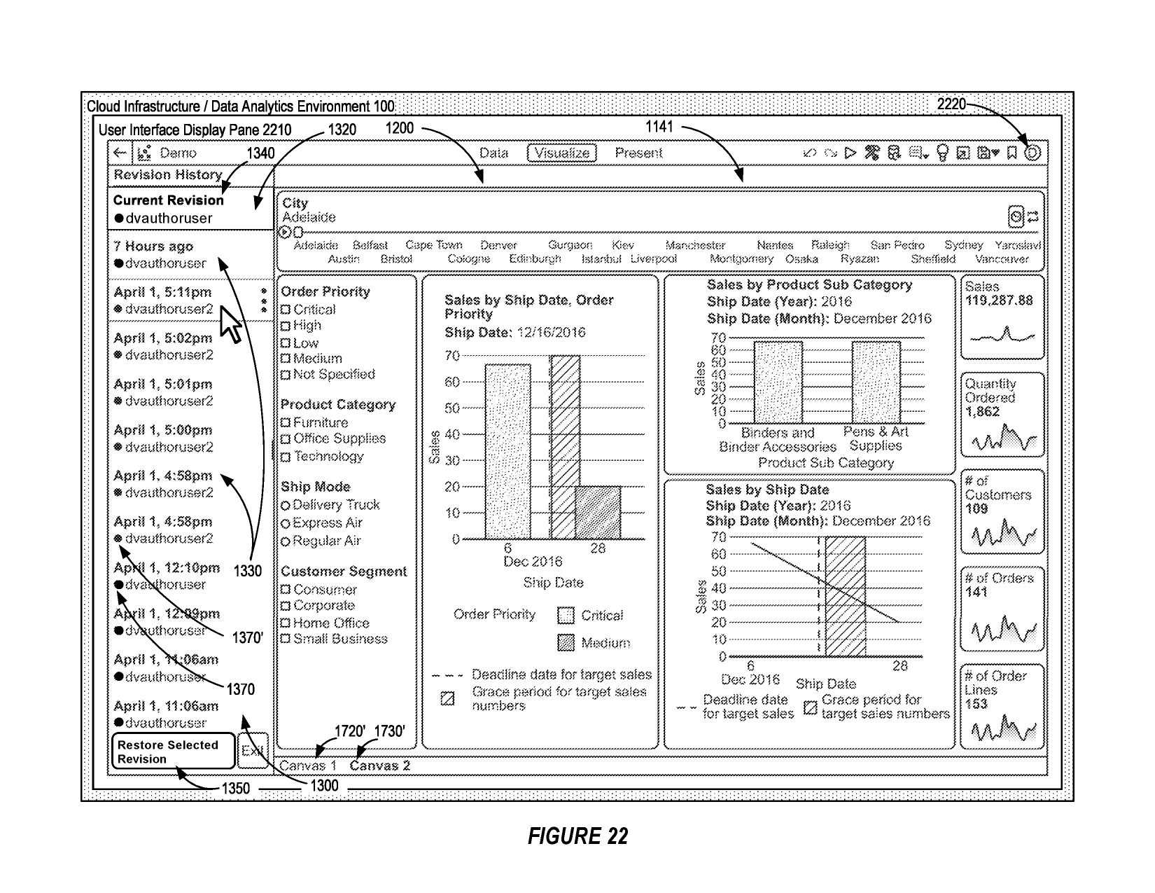

In accordance with the example embodiment illustrated, the revision history handler application 1110 is responsive to an initialization request such as shown for example at 2220 in FIG. 22 received from the user interface 1120 to provide to the user interface 1120 one or more of the current workbook 1141, the current workbook metadata 1143, and/or one or more of the plurality of previous workbook versions of the current workbook 1141 based on one or more of the plurality of previous workbook version metadata sets 1147 in a revisions.json file 1148.

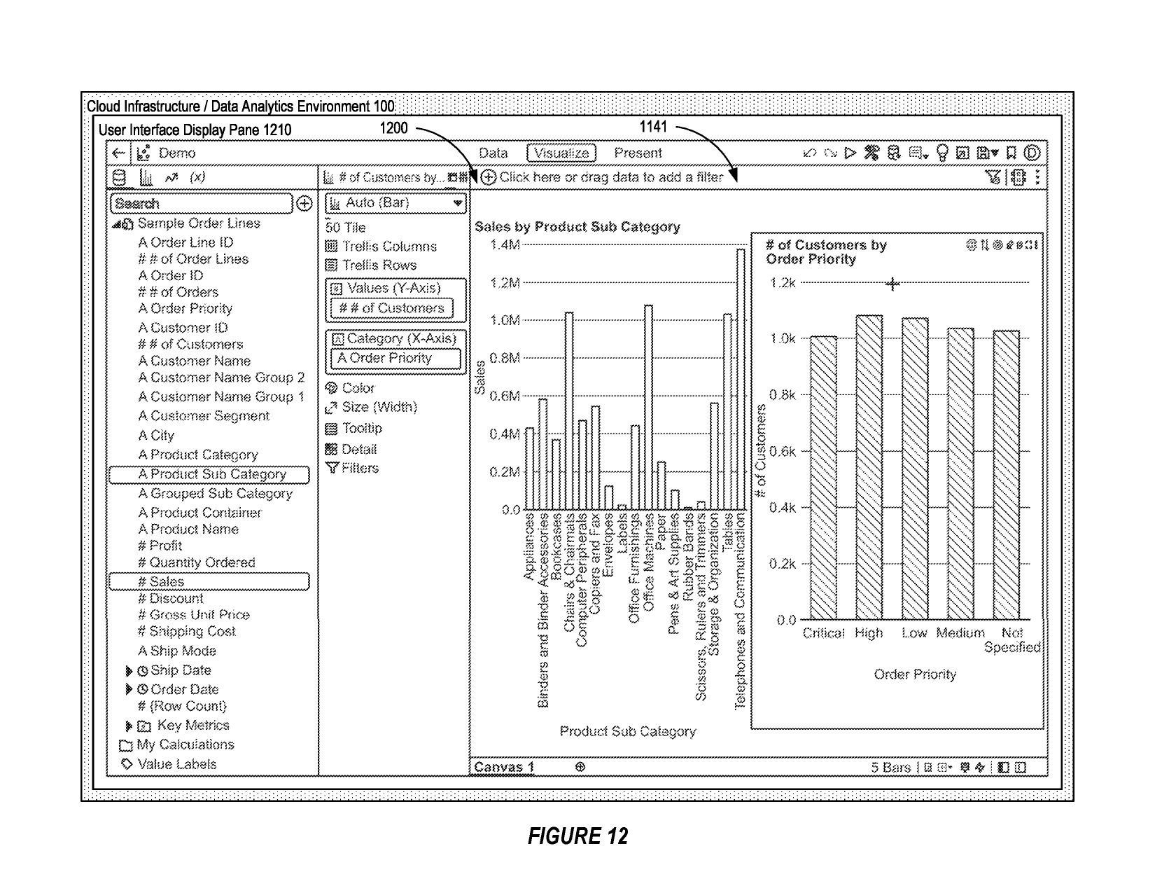

In accordance with the example embodiment illustrated, the user interface 1120 is operable to display the current workbook 1141 in an active edit display pane 1200 (FIGS. 12, 13, 17, 18, 20, and 21) of the client device 10 that is configured to receive current workbook change commands for making changes to the current workbook 1141 at the client device 10 by a user of the system 1100.

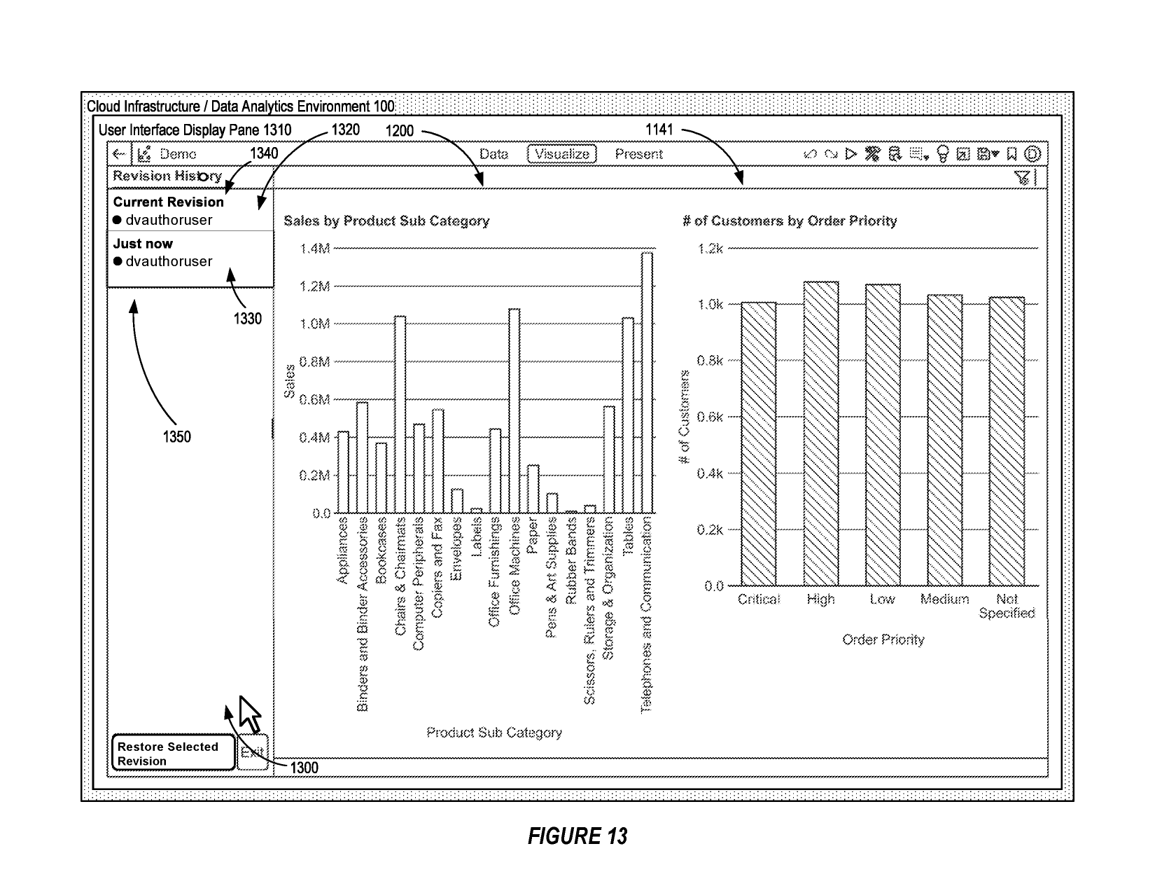

In accordance with the example embodiment illustrated, the user interface 1120 is operable to display in a revision history display pane 1300 (FIGS. 13, 14, 15, 16, 18, 19, and 21) of the client device 10 a current version history image 1320 based on the current workbook metadata 1143 relating to the current workbook 1141 displayed in the active edit display pane 1200 and a plurality of previous version history images 1330 based on the plurality of previous workbook version metadata sets 1147 each being related to the corresponding ones of the plurality of previous workbook versions.

In accordance with the example embodiment illustrated, the user interface 1120 comprises a version control service 1122 running at the client device 10. The version control service 1122 of the example embodiment is in operative communication with a cache 1124 at the client device 10, wherein the version control service 1122 is operable to persist one or more of the current workbook 1141, the current workbook metadata 1143, one or more of the previous workbook versions, and/or one or more of the plurality of previous workbook version metadata sets 1147 received from the revision history handler application 1110 in the cache 1124.

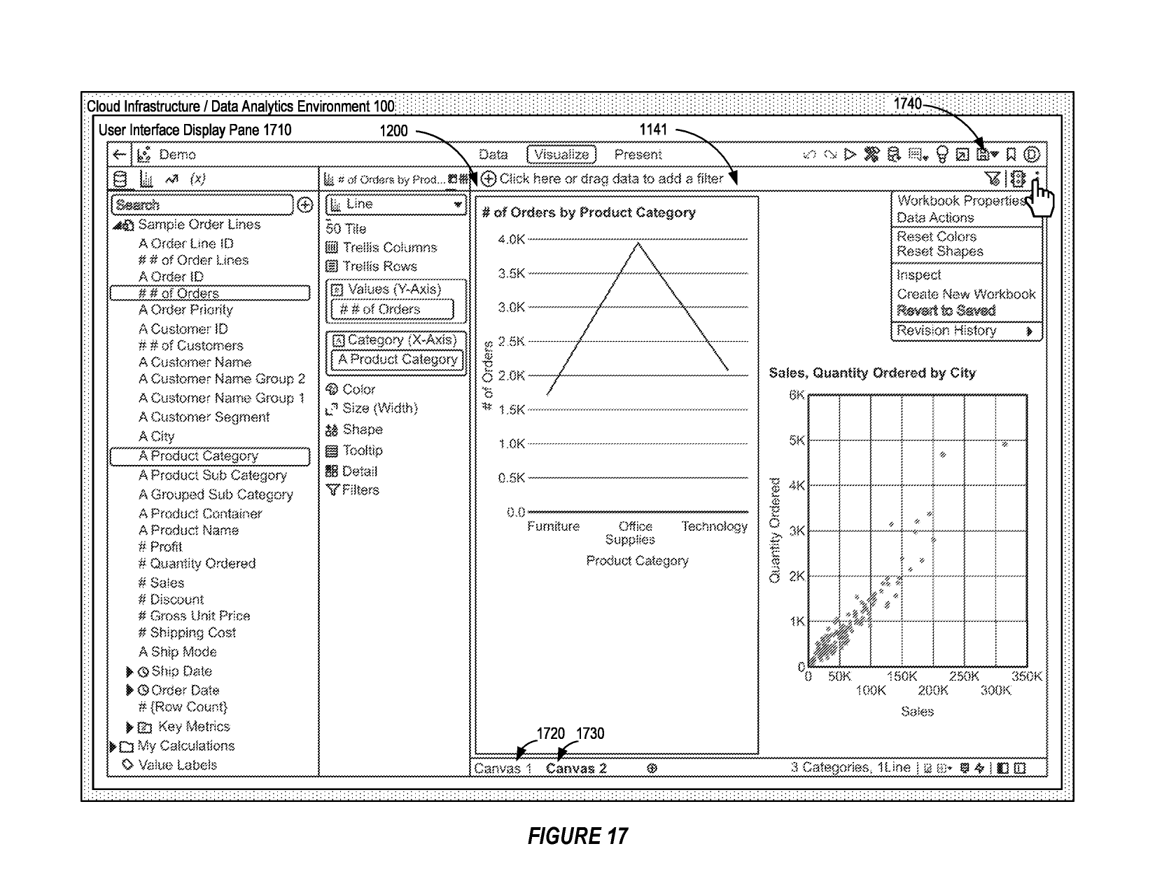

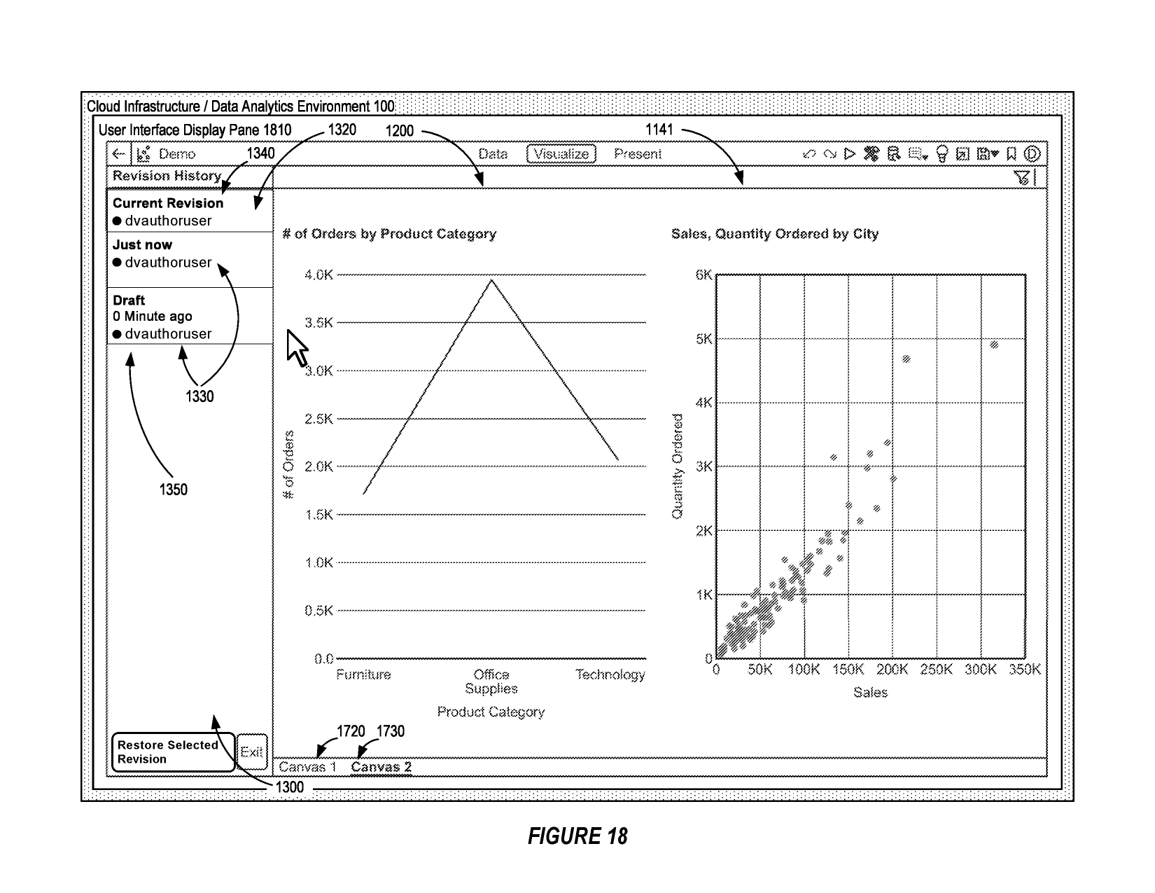

In accordance with the example embodiment illustrated, the user interface 1120 is operable to receive the current workbook change commands for making the changes to the current workbook 1141 at the client device by the user of the system. The changes may be to add a further canvas 1730 (FIGS. 17 and 18) to the initial canvas 1720 for example. The user interface 1120 is operable to generate, based on the changes made to the current workbook 1141, an updated workbook and updated workbook metadata related to the updated workbook. The user interface 1120 is further operable to display the updated workbook in the active edit display pane 1200 of the client device 10.

In addition and in accordance with the example embodiment illustrated, the version control service 1122 is operable to selectively, in response to a save command 1740 (FIG. 17) received from the user via the active edit display pane 1200, persist the updated workbook and the updated workbook metadata to the cache 1124 at the client device 10.

In accordance with the example embodiment illustrated, the version control service 1122 is operable to communicate the updated workbook and the updated workbook metadata to the revision history handler application 1110 running at the data analytics environment 100 in response to receiving the save command 1740 from the user via the active edit display pane 200. In addition and in accordance with the example embodiment illustrated, the workbook folder 1132 of the artifacts catalog 1130 of the data analytics environment 100 comprises a revisions.json file 1148. The revision history handler application 1100 of the example embodiment is operable to save the updated workbook metadata to the revisions.json file 1148.

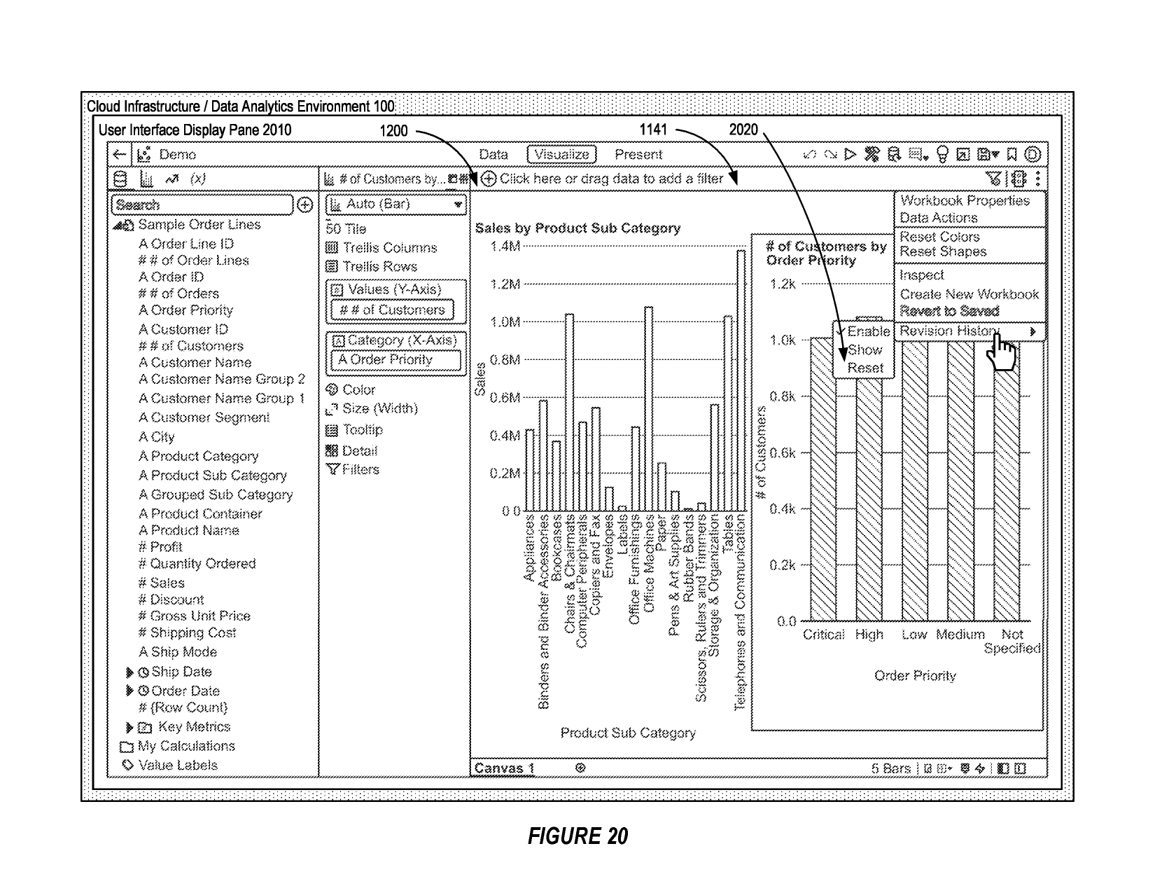

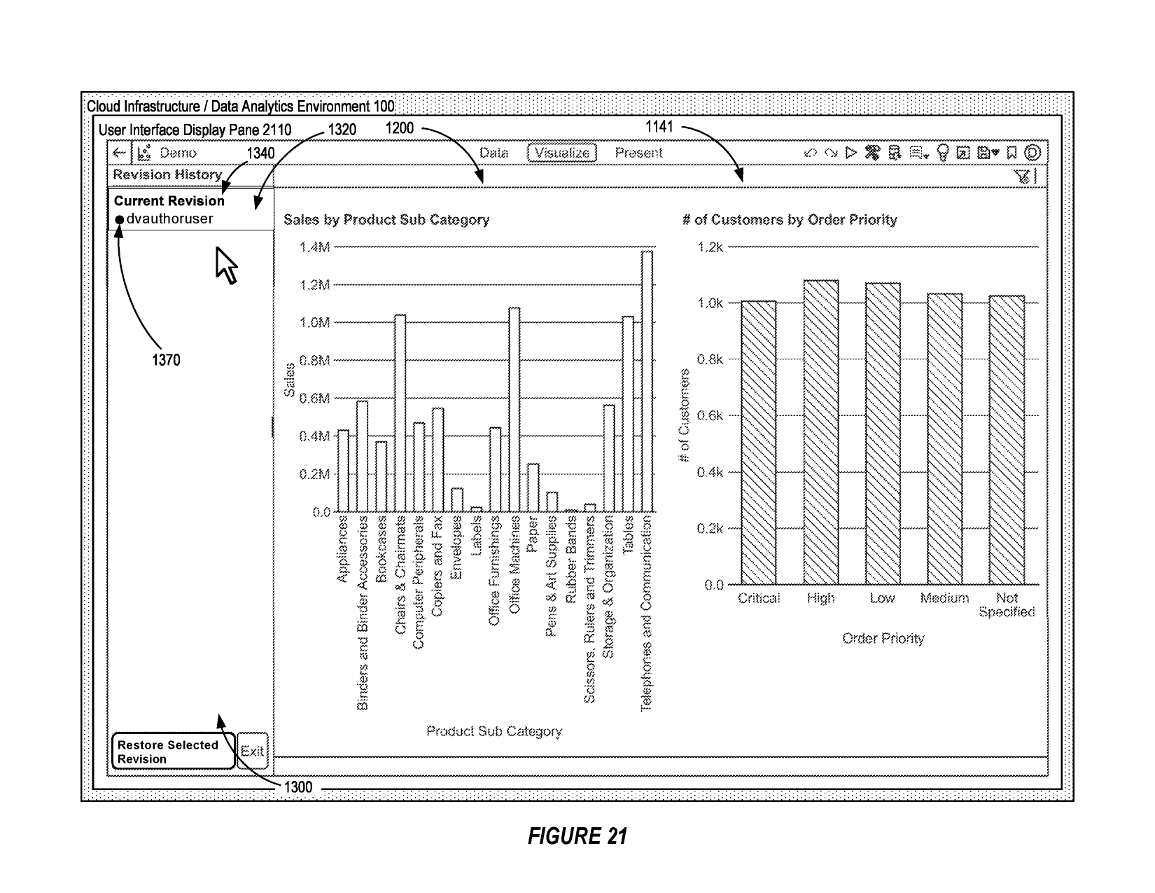

In accordance with the example embodiment illustrated, the user interface 1120 is operable to receive a reset request 2020 (FIG. 20) from the user, and the version control service 1122 is operable responsive to the user interface 1120 receiving the reset request 2020 to purge selected ones of the plurality of previous workbook version metadata sets from the cache 1124. In addition and in accordance with the example embodiment illustrated, a focused workbook is displayed in the active edit display pane 1200 of the client device 10 such as shown in the transition from the views shown from FIG. 20 to FIG. 21. Focused workbook metadata relating to the focused workbook being displayed (FIG. 21) in the active edit display pane 1200 are persisted to the cache 1124.

In accordance with the example embodiment illustrated, the user interface 1120 is operable to display the current version history image 1320 related to the current workbook metadata in the revision history display pane 1300 of the client device 10 in association with a first set of visual indicia 1340 indicating to the user of the client device that the current workbook displayed in the active edit display pane 1200 of the client device is a “Current Revision” of the current workbook.

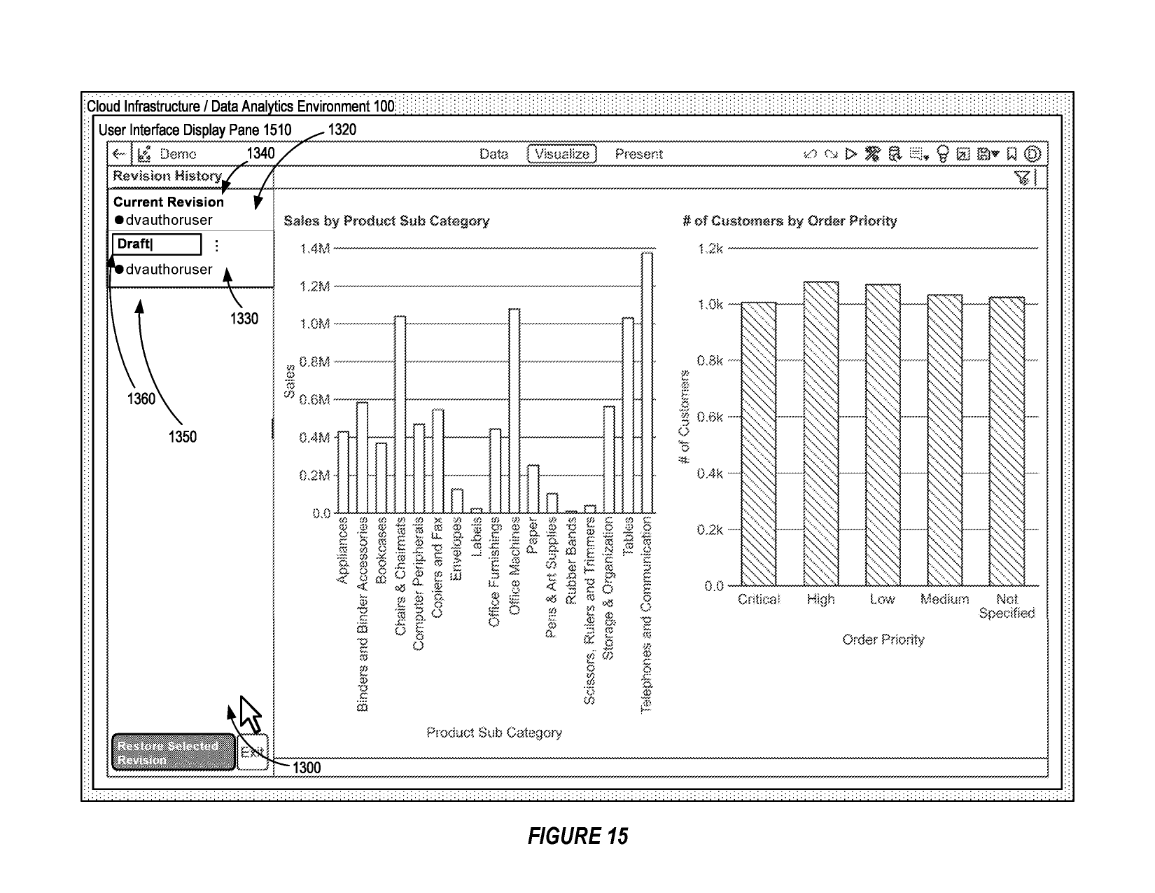

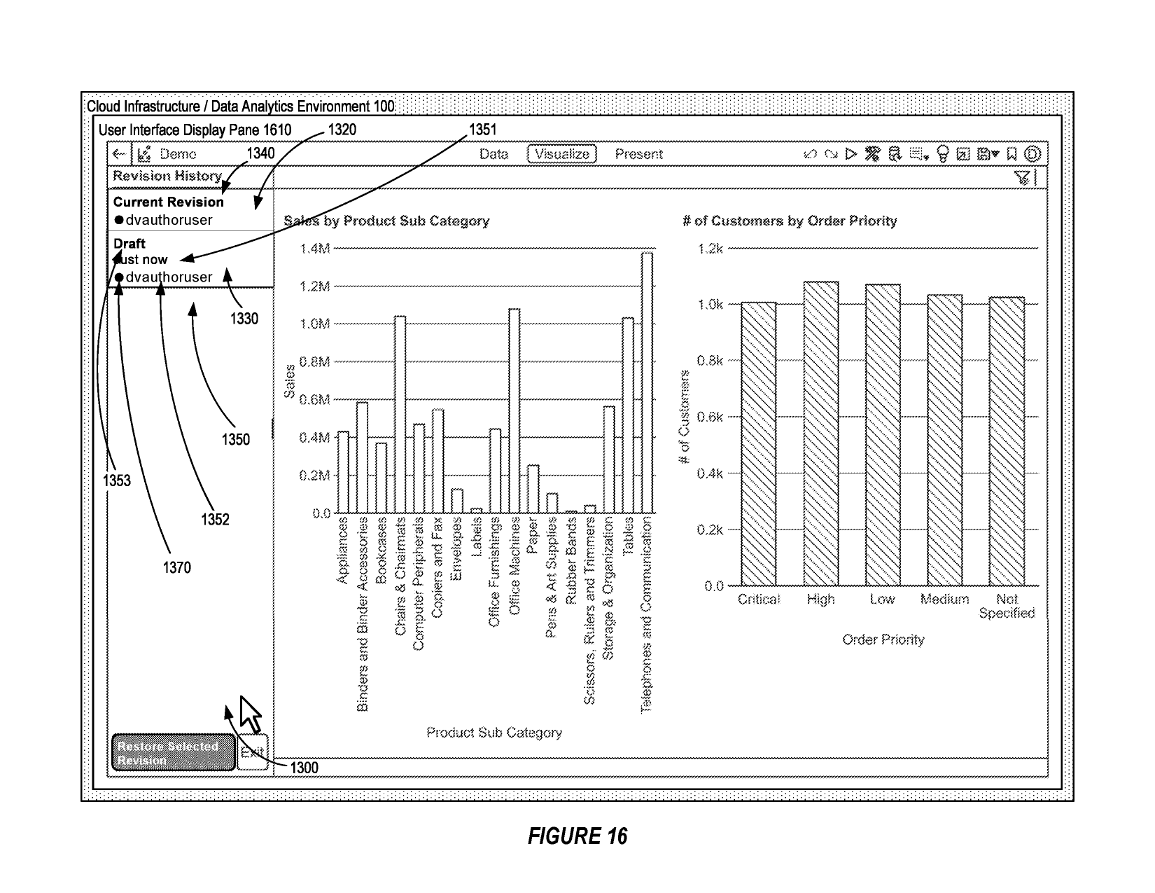

In addition, and in accordance with the example embodiment illustrated, the user interface 1120 is operable to display the plurality of previous version history images 1330 related to the plurality of previous workbook version metadata sets in the revision history display pane 1300 of the client device 10 in association with a second set of visual indicia 1350 indicating for each of the plurality of previous workbook versions one or more of a timestamp 1351 indicating a time at which that version was saved, an author 1352 of that version, a user that modified that version, a user that issued a save command to the version control service relative to that version, and/or a customized name 1353 of that version. As shown for example in FIG. 16 a customized name 1353 of “Draft” has been assigned to the most recent past or prior/earlier workbook version using a dialog box 1360 (FIG. 15) for example. In addition, and as shown in FIG. 22, each of the various users that authored and/or edited, modified or otherwise changed a workbook, and then saved that workbook to the system 100 may be individually identified using individualized indicia 1370. In addition and in accordance with an example embodiment, individualized indicia 1370 may be colorized wherein different colors of the indicia may be used to individually identify each of the various users that authored and/or edited, modified or otherwise changed a workbook, and then saved that workbook to the system 100. This is shown for example in FIG. 22 wherein the user “dvauthoruser” is identified using a first indicia 1370, and wherein the user “dvauthoruser2” is identified using a second indicia 1370’, wherein each of the first and second indicia 1370, 1370’ have different visual colors.

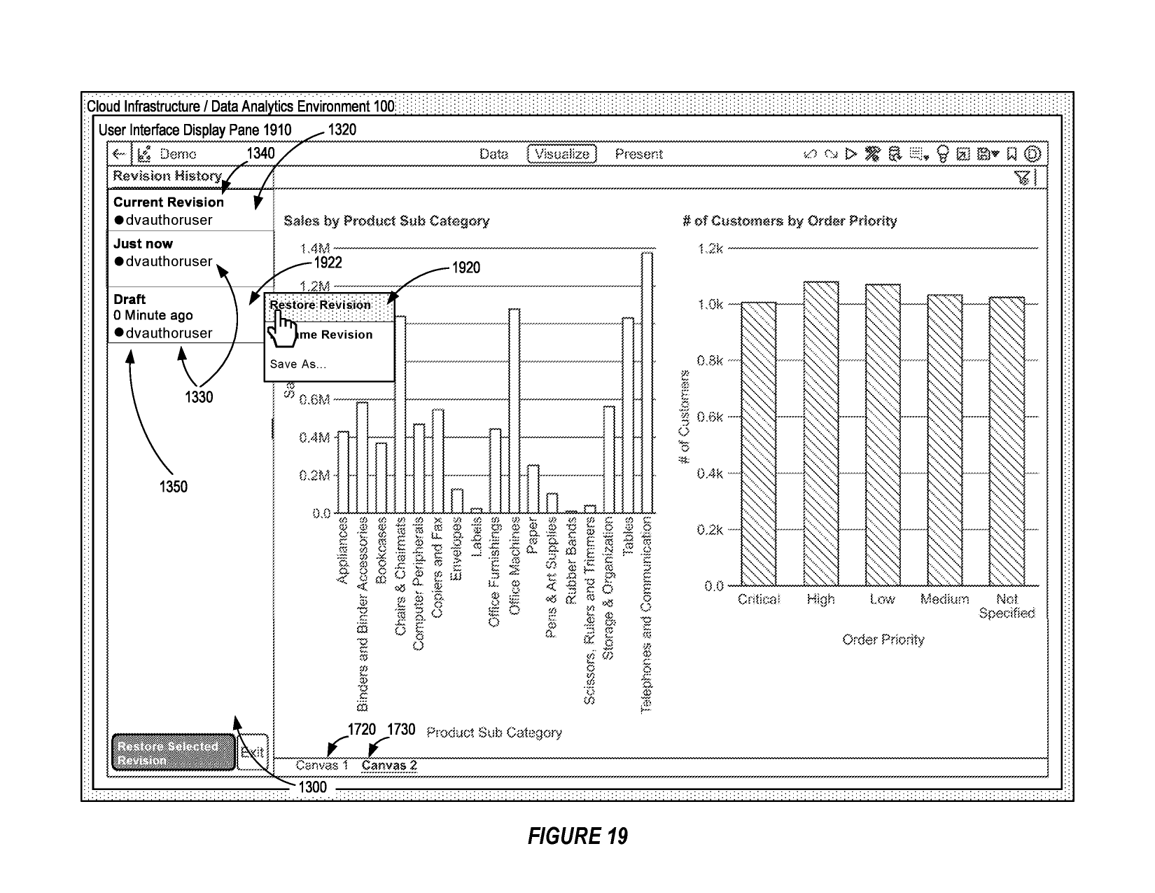

In accordance with the example embodiment illustrated, the user interface 1120 is further operable to receive a desired previous workbook restore request 1920 (FIG. 19) based on the user selecting a desired previous version history image from among the plurality of previous version history images 1330 displayed in the revision history display pane 1300 of the client device 10, wherein the selected desired previous version history image 1922 is related to a desired previous workbook version metadata set from among the plurality of previous workbook version metadata sets, the desired previous workbook version metadata set corresponding to a desired previous workbook version, identified in FIG. 19 using the user-applied (FIGS. 15 and 16) label of “Draft.”

In addition, and in accordance with an example embodiment, the user interface 1120 is still further operable to restore the desired previous workbook version for display in the active edit display pane 1200 of the client device 10 for making changes to the desired previous workbook version at the client device by the user of the system.

FIG. 12 illustrates a screenshot produced by a system to provide revision history for use with a data analytics environment, in accordance with an embodiment.

In accordance with an embodiment, a screenshot of a workbook within a data analytics environment is shown in FIG. 12, where a user has created a new workbook and is in the process of editing or otherwise modifying the newly created workbook.

In accordance with an embodiment, for every change within the workbook that is saved, the revision history creates a snapshot of the workbook, including filters, layouts, visualizations and other configurations.

FIG. 13 illustrates a screenshot produced by a system to provide revision history for use with a data analytics environment, in accordance with an embodiment.

In accordance with an embodiment, a screenshot of a workbook within a data analytics environment is shown in FIG. 13, where a user has save the workbook of FIG. 12 and thereby created a new “Current Revision” workbook and is in the process of editing or otherwise modifying the newly created “Current Revision” workbook.

In accordance with an embodiment, for every change within the workbook that is saved, the revision history creates a snapshot of the workbook, including filters, layouts, visualizations and other configurations.

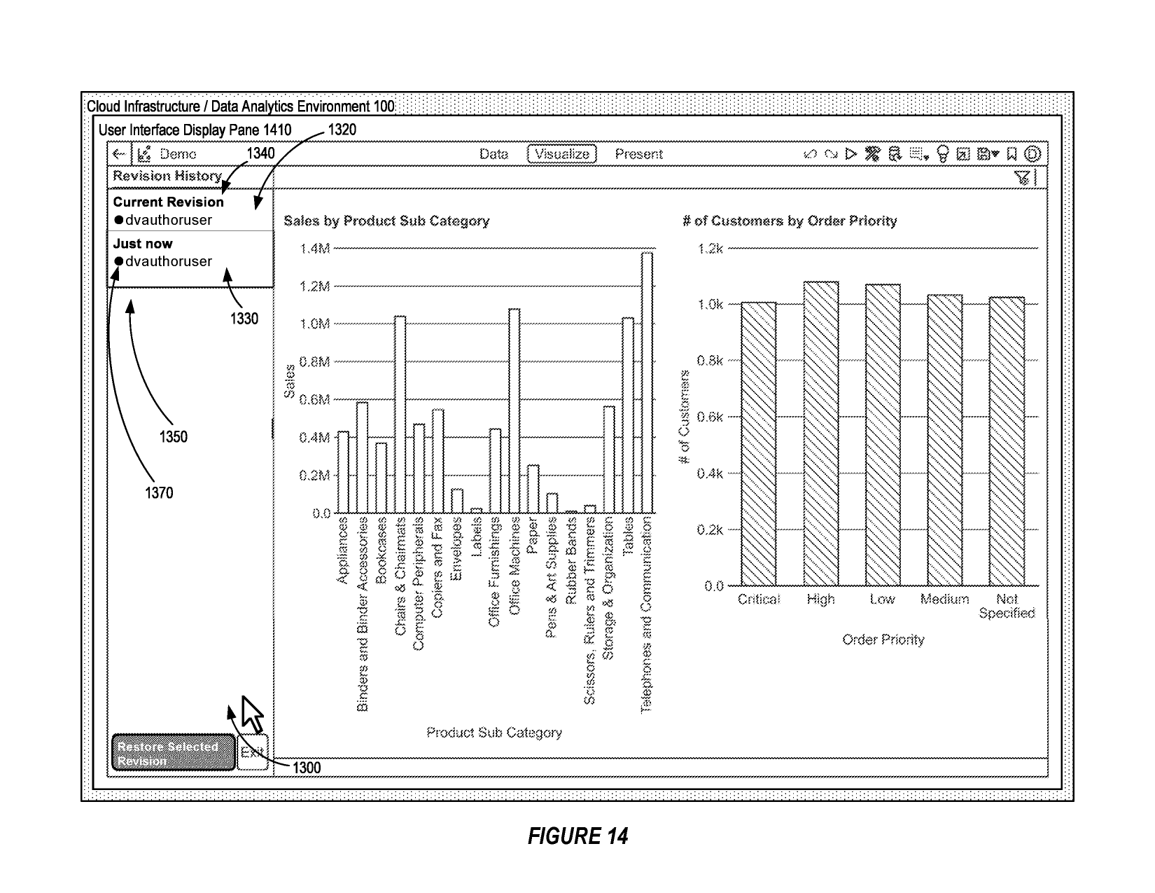

FIG. 14 illustrates a screenshot produced by a system to provide revision history for use with a data analytics environment, in accordance with an embodiment.

In accordance with an embodiment, a screenshot of a workbook within a data analytics environment is shown in FIG. 14, where a user is provided with one or more dialog boxes including a dialog box for controlling the system to restore a previous version of a workbook and a dialog box for controlling the system to rename a previous version of a workbook.

FIG. 15 illustrates a screenshot produced by a system to provide revision history for use with a data analytics environment, in accordance with an embodiment.

In accordance with an embodiment, a screenshot of a workbook within a data analytics environment is shown in FIG. 15, where a user is actively engaged with interacting with a dialog box for controlling the system to rename a previous version of a workbook.

In accordance with an embodiment, the name “Just now” of the previous version of the workbook (FIG. 14) is actively in FIG. 15 being renamed to “Draft.”

FIG. 16 illustrates a screenshot produced by a system to provide revision history for use with a data analytics environment, in accordance with an embodiment.

In accordance with an embodiment, a screenshot of a workbook within a data analytics environment is shown in FIG. 16, where the user has successfully renamed the previous version of the workbook from “Just now” (FIG. 14) “Draft” (FIG. 16).

FIG. 17 illustrates a screenshot produced by a system to provide revision history for use with a data analytics environment, in accordance with an embodiment.

In accordance with an embodiment, as shown in FIG. 17, shows a screenshot of a workbook within a data analytics environment where a user has added a second canvas to the workbook shown in FIGS. 12-16. As shown, by selecting a version of the workbook from the revision history pane, the version of the workbook having both canvas 1 and canvas 2 is displayed.

In accordance with an embodiment, for every change within the workbook that is saved, the revision history creates a snapshot of the workbook, including filters, layouts, visualizations and other configurations.

FIG. 18 illustrates a screenshot produced by a system to provide revision history for use with a data analytics environment, in accordance with an embodiment.

In accordance with an embodiment, as shown in FIG. 18, a workbook has three versions within a revision history panel (shown left), where the user may select any of the saved version histories, together with the workbook, including any filters, layouts, visualizations or other configurations.

In accordance with an embodiment, for every change within the workbook that is saved, the revision history creates a snapshot of the workbook, including filters, layouts, visualizations and other configurations.

FIG. 19 illustrates a screenshot produced by a system to provide revision history for use with a data analytics environment, in accordance with an embodiment.

In accordance with an embodiment, as shown in FIG. 19, shows a screenshot of a workbook within a data analytics environment where a user has added a second canvas to the workbook shown in FIGS. 12-16. As shown, by selecting an option to restore the workbook to a prior version, the systems and methods can restore the workbook to the prior version of where only one canvas was present.

In accordance with an embodiment, for every change within the workbook that is saved, the revision history creates a snapshot of the workbook, including filters, layouts, visualizations and other configurations.

FIG. 20 illustrates a screenshot produced by a system to provide revision history for use with a data analytics environment, in accordance with an embodiment.

In accordance with an embodiment, as shown in FIG. 20, shows a screenshot of a workbook within a data analytics environment where a user is provided with one or more dialog boxes including a dialog box for controlling the system to be reset.

In any of the embodiments herein, the user interface is operable to receive a reset request from the user, and the version control service is operable responsive to the user interface receiving the reset request to purge selected ones of the plurality of previous workbook version metadata sets from the cache, wherein a focused workbook being displayed in the active edit display pane of the client device and focused workbook metadata relating to the focused workbook being displayed in the active edit display pane are persisted to the cache.

In accordance with an embodiment, for every change within the workbook that is saved, the revision history creates a snapshot of the workbook, including filters, layouts, visualizations and other configurations.

FIG. 21 illustrates a screenshot produced by a system to provide revision history for use with a data analytics environment, in accordance with an embodiment.

In accordance with an embodiment, as shown in FIG. 21, shows a screenshot of a workbook within a data analytics environment where a user controlled the system to be reset.

The version control service is operable responsive to the user interface receiving the reset request to purge selected ones of the plurality of previous workbook version metadata sets from the cache, wherein a focused workbook being displayed in the active edit display pane of the client device and focused workbook metadata relating to the focused workbook being displayed in the active edit display pane are persisted to the cache.

FIG. 22 illustrates a screenshot produced by a system to provide revision history for use with a data analytics environment, in accordance with an embodiment.

In accordance with an embodiment, as shown in FIG. 22, shows a screenshot of a workbook within a data analytics environment where multiple users were working within the same workbook. Each of the version histories appearing in the left-side pane indicate which user was responsible for saving a respective version of the workbook.

In accordance with an embodiment, for every change within the workbook that is saved, the revision history creates a snapshot of the workbook, including filters, layouts, visualizations and other configurations.

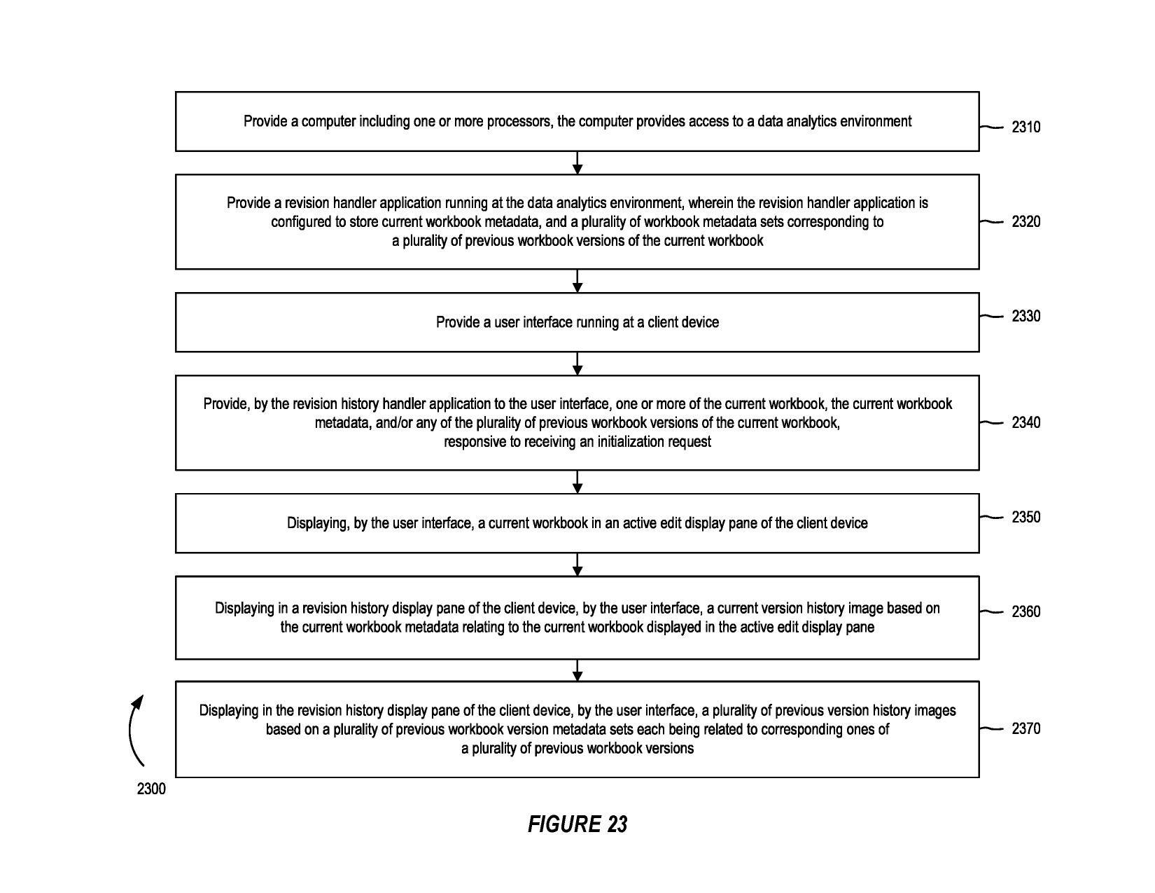

FIG. 23 illustrates a flowchart of a method 2300 for use with a data analytics environment to provide a revision history for use with a data analytics environment, in accordance with an embodiment.

In accordance with a further aspect, a method 2300 is provided for use with a data analytics environment to provide a workbook revision history of changes made to a workbook for use with the data analytics environment. The method includes providing, at step 2310, a computer including one or more processors, wherein the computer provides access to the data analytics environment.

In accordance with an embodiment, at step 2320, the method can provide a revision history handler application running at the data analytics environment, wherein the revision history handler application is configured to store, in a workbook folder of an artifacts catalog of the data analytics environment, current workbook metadata relating to a current workbook, and a plurality of previous workbook version metadata sets each being related to a corresponding one of a plurality of previous workbook versions of the current workbook.

In accordance with an embodiment, at step 2330, the method can provide a user interface running at a client device, wherein the user interface is in operative communication with the revision history handler application.

In accordance with an embodiment, at step 2340, the method can provide, to the user interface by the revision history handler application responsive to receiving an initialization request received from the user interface, one or more of the current workbook, the current workbook metadata, and/or any of the plurality of previous workbook versions of the current workbook.

The method includes displaying, at step 2350, by the user interface, the current workbook in an active edit display pane of the client device that is configured to receive current workbook change commands for making changes to the current workbook at the client device by a user of the system.

The method includes displaying, at step 2360, in a revision history display pane of the client device, by the user interface, a current version history image based on the current workbook metadata relating to the current workbook displayed in the active edit display pane.

The method includes displaying, at step 2370, in the revision history display pane of the client device, by the user interface, and a plurality of previous version history images based on the plurality of previous workbook version metadata sets each being related to the corresponding ones of the plurality of previous workbook versions.

In accordance with various embodiments, the systems and methods described herein can be implemented using one or more computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art. For example, although several of the examples provided herein illustrate use with cloud environments such as Oracle Analytics Cloud; in accordance with various embodiments, the systems and methods described herein can be used with other types of enterprise software applications, cloud environments, cloud services, cloud computing, or other computing environments.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

What is claimed is:

1. A system for use with a data analytics environment to provide a workbook revision history of changes made to a workbook for use with the data analytics environment, the system comprising:
a computer including one or more processors, that provides access to the data analytics environment;
a revision history handler application running at the data analytics environment, wherein the revision history handler application is configured to store, in a workbook folder of an artifacts catalog of the data analytics environment, current workbook metadata relating to a current workbook, and a plurality of previous workbook version metadata sets each being related to a corresponding one of a plurality of previous workbook versions of the current workbook; and
a user interface running at a client device and being in operative communication with the revision history handler application,
wherein the revision history handler application is responsive to an initialization request received from the user interface to provide to the user interface one or more of the current workbook, the current workbook metadata, and/or any of the plurality of previous workbook versions of the current workbook,
wherein the user interface is operable to display the current workbook in an active edit display pane of the client device that is configured to receive current workbook change commands for making changes to the current workbook at the client device by a user of the system,
wherein the user interface is operable to display in a revision history display pane of the client device a current version history image based on the current workbook metadata relating to the current workbook displayed in the active edit display pane and a plurality of previous version history images based on the plurality of previous workbook version metadata sets each being related to the corresponding ones of the plurality of previous workbook versions.

2. The system according to claim 1, wherein:
the user interface comprises a version control service running at the client device, the version control service being in operative communication with a cache at the client device,
wherein the version control service is operable to persist one or more of the current workbook, the current workbook metadata, and/or the plurality of previous workbook version metadata sets received from the revision history handler application in the cache at the client device.

3. The system according to claim 2, wherein:
the user interface is operable to:
receive the current workbook change commands for making the changes to the current workbook at the client device by the user of the system;
generate, based on the changes made to the current workbook, an updated workbook and updated workbook metadata related to the updated workbook; and
display the updated workbook in the active edit display pane of the client device; and
the version control service is operable to:
selectively, in response to a save command received from the user via the active edit display pane, persist the updated workbook and the updated workbook metadata to the cache at the client device.

4. The system according to claim 3, wherein:
the version control service is operable to communicate the updated workbook and the updated workbook metadata to the revision history handler application running at the data analytics environment in response to receiving the save command from the user via the active edit display pane;
the workbook folder of the artifacts catalog of the data analytics environment comprises a revisions.json file; and
the revision history handler application is operable to save the updated workbook metadata to the revisions.json file.

5. The system according to claim 2, wherein:
the user interface is operable to receive a reset request from the user; and
the version control service is operable responsive to the user interface receiving the reset request to purge selected ones of the plurality of previous workbook version metadata sets from the cache at the client device,
wherein a focused workbook being displayed in the active edit display pane of the client device and focused workbook metadata relating to the focused workbook being displayed in the active edit display pane are persisted to the cache at the client device.

6. The system according to claim 1, wherein:
the user interface is operable to display the current version history image related to the current workbook metadata in the revision history display pane of the client device in association with a first set of visual indicia indicating to the user of the client device that the current workbook displayed in the active edit display pane of the client device is a Current Revision of the current workbook; and
the user interface is operable to display the plurality of previous version history images related to the plurality of previous workbook version metadata sets in the revision history display pane of the client device in association with a second set of visual indicia indicating for each of the plurality of previous workbook versions one or more of:
a timestamp indicating a time at which that version was saved;
an author of that version;
a user that modified that version;
a user that issued a save command to the version control service relative to that version; and/or
a customized name of that version.

7. The system according to claim 1, wherein:
the user interface is operable to receive a desired previous workbook restore request based on the user selecting a desired previous version history image from among the plurality of previous version history images displayed in the revision history display pane of the client device, the selected desired previous version history image being related to a desired previous workbook version metadata set from among the plurality of previous workbook version metadata sets, the desired previous workbook version metadata set corresponding to a desired previous workbook version; and
the user interface is operable to restore the desired previous workbook version for display in the active edit display pane of the client device for making changes to the desired previous workbook version at the client device by the user of the system.

8. A method for use with a data analytics environment to provide a workbook revision history of changes made to a workbook for use with the data analytics environment, the method comprising:
providing a computer including one or more processors, wherein the computer provides access to the data analytics environment;
providing a revision history handler application running at the data analytics environment, wherein the revision history handler application is configured to store, in a workbook folder of an artifacts catalog of the data analytics environment, current workbook metadata relating to a current workbook, and a plurality of previous workbook version metadata sets each being related to a corresponding one of a plurality of previous workbook versions of the current workbook;
providing a user interface running at a client device, wherein the user interface is in operative communication with the revision history handler application;
providing to the user interface, by the revision history handler application responsive to receiving an initialization request received from the user interface, one or more of the current workbook, the current workbook metadata, the current workbook metadata, and/or any of the plurality of previous workbook versions of the current workbook based on the previous workbook metadata sets;
displaying, by the user interface, the current workbook in an active edit display pane of the client device that is configured to receive current workbook change commands for making changes to the current workbook at the client device by a user of the system; and
displaying in a revision history display pane of the client device, by the user interface, a current version history image based on the current workbook metadata relating to the current workbook displayed in the active edit display pane and a plurality of previous version history images based on the plurality of previous workbook version metadata sets each being related to the corresponding ones of the plurality of previous workbook versions.

9. The method according to claim 8, further comprising:
providing a version control service running at the client device, the version control service being in operative communication with a cache at the client device; and
persisting, by the version control service, one or more of the current workbook, the current workbook metadata, and/or the plurality of previous workbook version metadata sets received from the revision history handler application in the cache at the client device.

10. The method according to claim 9, further comprising:
receiving, by the user interface, the current workbook change commands for making the changes to the current workbook at the client device by the user of the system;
generating, by the user interface based on the changes made to the current workbook, an updated workbook and updated workbook metadata related to the updated workbook;
displaying, by the user interface, the updated workbook in the active edit display pane of the client device; and
selectively persisting, by the version control service in response to a save command received from the user via the active edit display pane, the updated workbook and the updated workbook metadata to the cache at the client device.

11. The method according to claim 10, further comprising:
communicating, by the version control service, the updated workbook and the updated workbook metadata to the revision history handler application running at the data analytics environment in response to receiving the save command from the user via the active edit display pane; and
saving, by the revision history handler application, the updated workbook metadata to a revisions.json file of the workbook folder of the artifacts catalog of the data analytics environment.

12. The method according to claim 9, further comprising:
receiving, by the user interface, a reset request from the user;
purging, by the version control service responsive to the user interface receiving the reset request, selected ones of the plurality of previous workbook version metadata sets from the cache at the client device; and
persisting to the cache at the client device, by the version control service, a focused workbook being displayed in the active edit display pane of the client device and focused workbook metadata relating to the focused workbook being displayed in the active edit display pane.

13. The method according to claim 8, further comprising:
displaying, by the user interface, the current version history image related to the current workbook metadata in the revision history display pane of the client device in association with a first set of visual indicia indicating to the user of the client device that the current workbook displayed in the active edit display pane of the client device is a Current Revision of the current workbook; and
displaying, by the user interface, the plurality of previous version history images related to the plurality of previous workbook version metadata sets in the revision history display pane of the client device in association with a second set of visual indicia indicating for each of the plurality of previous workbook versions one or more of:
a timestamp indicating a time at which that version was saved;
an author of that version;
a user that modified that version;
a user that issued a save command to the version control service relative to that version; and/or
a customized name of that version.

14. The method according to claim 8, further comprising:
receiving, by the user interface, a desired previous workbook restore request based on the user selecting a desired previous version history image from among the plurality of previous version history images displayed in the revision history display pane of the client device, the selected desired previous version history image being related to a desired previous workbook version metadata set from among the plurality of previous workbook version metadata sets, the desired previous workbook version metadata set corresponding to a desired previous workbook version; and
restoring, by the user interface, the desired previous workbook version for display in the active edit display pane of the client device for making changes to the desired previous workbook version at the client device by the user of the system.

15. A non-transitory computer readable medium having instructions thereon for use with a data analytics environment to provide a workbook revision history of changes made to a workbook for use with the data analytics environment, that when run and executed cause the computer to perform steps comprising:
providing a computer including one or more processors, wherein the computer provides access to the data analytics environment;
providing a revision history handler application running at the data analytics environment, wherein the revision history handler application is configured to store, in a workbook folder of an artifacts catalog of the data analytics environment, current workbook metadata relating to a current workbook, and a plurality of previous workbook version metadata sets each being related to a corresponding one of a plurality of previous workbook versions of the current workbook;
providing a user interface running at a client device, wherein the user interface is in operative communication with the revision history handler application;
providing to the user interface, by the revision history handler application responsive to receiving an initialization request received from the user interface, one or more of the current workbook, the current workbook metadata, the current workbook metadata, and/or any of the plurality of previous workbook versions of the current workbook based on the previous workbook metadata sets;
displaying, by the user interface, the current workbook in an active edit display pane of the client device that is configured to receive current workbook change commands for making changes to the current workbook at the client device by a user of the system; and
displaying in a revision history display pane of the client device, by the user interface, a current version history image based on the current workbook metadata relating to the current workbook displayed in the active edit display pane and a plurality of previous version history images based on the plurality of previous workbook version metadata sets each being related to the corresponding ones of the plurality of previous workbook versions.

16. The non-transitory computer readable medium according to claim 15, wherein the instructions thereon when run and executed cause the computer to perform further steps comprising:
providing a version control service running at the client device, the version control service being in operative communication with a cache at the client device; and
persisting, by the version control service, one or more of the current workbook, the current workbook metadata, and/or the plurality of previous workbook version metadata sets received from the revision history handler application in the cache at the client device.

17. The non-transitory computer readable medium according to claim 16, wherein the instructions thereon when run and executed cause the computer to perform further steps comprising:
receiving, by the user interface, the current workbook change commands for making the changes to the current workbook at the client device by the user of the system;
generating, by the user interface based on the changes made to the current workbook, an updated workbook and updated workbook metadata related to the updated workbook;
displaying, by the user interface, the updated workbook in the active edit display pane of the client device; and
selectively persisting, by the version control service in response to a save command received from the user via the active edit display pane, the updated workbook and the updated workbook metadata to the cache at the client device.

18. The non-transitory computer readable medium according to claim 16, wherein the instructions thereon when run and executed cause the computer to perform further steps comprising:
receiving, by the user interface, a reset request from the user;
purging, by the version control service responsive to the user interface receiving the reset request, selected ones of the plurality of previous workbook version metadata sets from the cache at the client device; and
persisting to the cache at the client device, by the version control service, a focused workbook being displayed in the active edit display pane of the client device and focused workbook metadata relating to the focused workbook being displayed in the active edit display pane.

19. The non-transitory computer readable medium according to claim 15, wherein the instructions thereon when run and executed cause the computer to perform further steps comprising:
displaying, by the user interface, the current version history image related to the current workbook metadata in the revision history display pane of the client device in association with a first set of visual indicia indicating to the user of the client device that the current workbook displayed in the active edit display pane of the client device is a Current Revision of the current workbook; and
displaying, by the user interface, the plurality of previous version history images related to the plurality of previous workbook version metadata sets in the revision history display pane of the client device in association with a second set of visual indicia indicating for each of the plurality of previous workbook versions one or more of:
a timestamp indicating a time at which that version was saved;
an author of that version;
a user that modified that version;
a user that issued a save command to the version control service relative to that version; and/or
a customized name of that version.

20. The non-transitory computer readable medium according to claim 15, wherein the instructions thereon when run and executed cause the computer to perform further steps comprising:
receiving, by the user interface, a desired previous workbook restore request based on the user selecting a desired previous version history image from among the plurality of previous version history images displayed in the revision history display pane of the client device, the selected desired previous version history image being related to a desired previous workbook version metadata set from among the plurality of previous workbook version metadata sets, the desired previous workbook version metadata set corresponding to a desired previous workbook version; and
restoring, by the user interface, the desired previous workbook version for display in the active edit display pane of the client device for making changes to the desired previous workbook version at the client device by the user of the system.
